(19) United States
(12) Patent Application Publication
(10) Pub. No.: US 2018/0130305 A1
(43) Pub. Date: May 10, 2018

(54) GAMING DEVICES WITH INTERGAME ENHANCEMENT VALUE APPLICABILITY

(71) Applicant: KING SHOW GAMES, INC., Minnetonka, MN (US)

(72) Inventors: Bradley BERMAN, Minnetonka, MN (US); Jacob LAMB, Maple Grove, MN (US)

(21) Appl. No.: 15/676,487

(22) Filed: Aug. 14, 2017

Related U.S. Application Data
(60) Provisional application No. 62/419,395, filed on Nov. 8, 2016.

(51) Int. Cl. G07F 17/32

(52) U.S. Cl. CPC G07F 17/3267; G07F 17/3213; G07F 17/3244

(57) ABSTRACT

Systems, apparatuses and methods for awarding an enhancement value(s) in connection with a gaming event occurring at a first time or sequence position, and applying that enhancement value to a payout result occurring at a second time or sequence position. Embodiments include applying a presently-obtained enhancement value(s) to a previously-obtained payout result(s).

### FIELD

This disclosure relates generally to games, and more particularly to systems, apparatuses and methods for applying value enhancers in different games from when they are triggered in gaming devices.

### BACKGROUND

Casino games such as poker, slots, and craps have long been enjoyed as a means of entertainment. Some of these games originated using traditional elements such as playing cards or dice. More recently, gaming devices have been developed to simulate and/or further enhance these games while remaining entertaining. The popularity of casino gambling with wagering continues to increase, as does recreational gambling such as non-wagering computer game gambling. Part of this popularity is due to the increased development of new types of games that are implemented, at least in part, on gaming devices.

One reason that casino games are widely developed for gaming devices is that a wide variety of games can be implemented on gaming devices, thereby providing an array of choices for players looking to gamble. For example, the graphics and sounds included in such games can be modified to reflect popular subjects, such as movies and television shows. Game play rules and types of games can also vary greatly providing many different styles of gambling. Additionally, gaming devices require minimal supervision to operate on a casino floor, or in other gambling environments. That is, as compared to traditional casino games that require a dealer, banker, stickman, pit managers, etc., gaming devices need much less employee attention to operate.

With the ability to provide new content, players have come to expect the availability of an ever wider selection of new games when visiting casinos and other gaming venues. Playing new games adds to the excitement of “gaming.” As is well known in the art and as used herein, the term “gaming” and “gaming devices” generally involves some form of wagering, and that players make wagers of value, whether actual currency or something else of value, e.g., token or credit. Wagering-type games usually provide rewards based on random chance as opposed to skill, although some skill may be an element in some types of games. Since random chance is a significant component of these games, they are sometimes referred to as “games of chance.”

The present disclosure describes systems, apparatuses and methods that facilitate new and interesting gaming experiences, and that provide advantages over the prior art.

### SUMMARY

The present disclosure is directed to systems, apparatuses and methods that involve or otherwise facilitate using enhancement values (also referred to herein as modifiers), such as multipliers, in different games from when they are triggered or otherwise originate.

The disclosure describes systems, apparatuses and methods for applying enhancement values to gaming payouts, where such enhancement values may increase or otherwise augment gaming payouts.

In one embodiment, an enhancement value(s) is awarded in a particular gaming event(s) of a game, where the enhancement value(s) is applied to other parts of the game, such as to other gaming events offset in time and/or space relative to the gaming event(s) in which the enhancement value(s) arises. Thus, enhancement values, such as multipliers, can thereby “time travel” for utilization with gaming events occurring at a previous time.

In other embodiments, such enhancement value(s) can time travel to subsequent gaming events.

In yet other embodiments, the enhancement value(s) can alternatively or additionally “space travel” to other gaming events such as in a multi-play game.

One embodiment involves a gaming apparatus that includes at least one display device to present a sequence of played gaming events as they are played. A processor is configured to apply an awarded enhancement value obtained in connection with the present gaming event to a past awarded payout obtained in connection with a past gaming event. In one embodiment, a wager input device is also provided, which is structured to receive physical items associated with player assets that enable participation on the gaming apparatus.

In another embodiment of such a gaming apparatus, the processor is further configured to randomly generate the enhancement value obtained in connection with the present gaming event, and may also randomly generate the past awarded payout obtained in connection with the past gaming event. The sequence of gaming events may involve a natural progression of played gaming events, such as successive “spin” operations in a slot game, and the display device may display these successive gaming events as they occur (e.g., display a past gaming event at a first time, and display the present gaming event at a second time). In one embodiment, the past gaming event is designated as the most recent past gaming event that resulted in the past awarded payout which is above some threshold, and where the processor applies the awarded enhancement value to the past awarded payout that is above the threshold. In another embodiment, the processor can determine whether the present gaming event results in a present winning payout, and conditions the application of the awarded enhancement value to the past awarded payout on whether the present gaming event resulted in the present winning payout. In still other embodiments, one or more past gaming events may be marked or otherwise designated for use with future enhancers/modifiers, where such marking/designation may be based on any desired conditions, such as reaching (or not reaching) some result or payout threshold.

In another embodiment, the trigger to enable the time or space travel itself can be based on time or duration (e.g., the last five events), and/or may be based on events occurring. For example, an event(s) may serve as a trigger, such as a particular symbol combination, occurrence of a bonus event, payout with a threshold value, etc. Thus, the triggering event may be tune-based, event-based, condition-based, etc.

Another embodiment involves a method, where a sequence of gaming events is presented, where at least some of the gaming events provide results indicative of winning or non-winning results. At least one enhancement value occurring in connection with a presently-occurring gaming event is presented and applied to the winning result of a previously-occurring gaming event.

In another embodiment, such a method may further involve identifying the most recent winning result(s), where applying the enhancement value(s) involves applying the enhancement value(s) to the identified most recent winning result.

Other embodiments of such a method may further include windows or ranges of past or future results. In one embodiment, such a method further includes identifying at least one window of consecutive gaming events occurring before the presently-occurring gaming event occurred, and designating the winning result of the previously-occurring gaming event as the highest winning payout result among the gaming events in the window. In another embodiment, such a method includes identifying at least one window of consecutive gaming events occurring before the presently-occurring gaming event occurred, and designating the winning result of the previously-occurring gaming event as one or more of the gaming events identified in the window, such as a random one of the results of gaming events in the window, a sum of two or more of the results of gaming events in the window, etc.

In yet other embodiments involving a window or range of past or future results, a gaming apparatus is provided. The gaming apparatus includes a display device (which may include one or more display areas) to display a plurality of sequential gaming events, including a present gaming event. A processor is configured to award an enhancement value obtained in connection with the present gaming event, to identify a window of consecutive sequential gaming events relative to the present gaming event, and to identify a payout quantity from the window in which to apply the awarded enhancement value to arrive at a total payout. In another embodiment, the gaming apparatus may also include a wager input device structured to receive physical items associated with player assets that enable participation on the gaming apparatus.

In another embodiment of such a gaming apparatus, the enhancement value is a multiplier, although it can be any value or function that enhances, augments, increases, otherwise changes the target payout result. In some embodiments, the processor is configured to identify the window as a number of consecutive sequential gaming events that immediately preceded the present gaming event, while in other embodiments the processor is further configured to generate a plurality of the windows, each having a different number of the consecutive sequential gaming events, and to designate at least one of the various windows as the window(s) in which to apply the awarded enhancement value to arrive at a total payout.

In yet other embodiments of such a gaming apparatus, the processor is configured to identify the window as a number of the consecutive gaming events that immediately succeed the present gaming event, while in other embodiments the processor is further configured to generate a plurality of the windows, each having a different number of consecutive sequential gaming events, and to designate at least one of the various windows as the window(s) in which to apply the awarded enhancement value to arrive at a total payout.

In other embodiments of such a gaming apparatus, the processor is configured to identify the payout quantity by identifying the highest value payout of the sequential gaming events that occurred during the window in which to apply the awarded enhancement value to arrive at the total payout. In other embodiments, the processor is configured to identify the payout quantity by identifying the average value payout of the sequential gaming events that occur during the window in which to apply the awarded enhancement value to arrive at the total payout. In still other embodiments, the processor is configured to identify the payout quantity by identifying a sum of payouts of the sequential gaming events occurring during the window in which to apply the awarded enhancement value to arrive at the total payout.

This summary serves as an abbreviated, selective introduction of a representative subset of various concepts and embodiments that are further described or taught to those skilled in the art in the Specification herein. This summary is not intended to refer to all embodiments, scopes, or breadths of claims otherwise supported by the Specification, nor to identify essential features of the claimed subject matter, nor to limit the scope of the claimed subject matter.

### BRIEF DESCRIPTION OF THE DRAWINGS

FIG. 1 is a diagram of a representative gaming machine capable of facilitating player use and interaction with games and features in accordance with the invention and representative embodiments described herein.

FIG. 2 is a block diagram illustrating a representative computing arrangement capable of implementing games and features in accordance with the invention and representative embodiments described herein.

FIGS. 3A-3C are block diagrams depicting representative embodiments of techniques for applying awarded gaming enhancers to gaming events occurring previously in time.

FIGS. 4A-4B are block diagrams depicting representative embodiments of techniques for applying awarded gaming enhancers to gaming events occurring later in time.

FIG. 5A depicts an exemplary slot game, or other gaming activity, of indeterminate size in which the principles described herein are applicable.

FIG. 5B depicts a sequence of slot game events illustrating a representative embodiment where an awarded enhancement value is applied to a winning payline award that occurred at a past time/sequence.

FIG. 5C depicts a sequence of slot game events illustrating a representative embodiment where an awarded enhancement value is applied to a winning payline award occurring at a future time/sequence.

FIG. 6 is a flow diagram of an embodiment for time traveling an awarded enhancement value(s).

FIGS. 7, 8 and 9 are flow diagrams of representative embodiments for awarding an enhancement value(s) in connection with a first gaming event, and applying that enhancement value(s) to a payout result(s) occurring at a different time or sequence position.

FIG. 10 is an example of a Backwards Window enabling an enhancement value to travel to apply to one or more previous payout results occurring within a prior time/sequence window.

FIGS. 11A and 11B depict representative examples of designating or selecting among a plurality of possible backwards windows (e.g., past time ranges) in which to identify a payout to apply to the time traveling enhancement value.

FIG. 12 is an example of a Forward Window enabling an enhancement value to travel to apply to one or more future payout results occurring within a future time/sequence window.

FIG. 13 depicts a representative example of designating or selecting among a plurality of possible forward windows (e.g., future time ranges) in which to identify a payout to apply to the time traveling enhancement value.

FIGS. 14A and 149 are flow diagrams of representative methods for utilizing time travel windows.

FIGS. 15A, 15B and 15C depict representative examples of an enhancement value space travel, where an enhancement value(s) awarded in at least one gaming event is applied to at least one other concurrently-played gaming event.

FIG. 16 depicts a representative example of an enhancement value space travel, where an enhancement value(s) awarded in portion of a gaming event is applied to another portion of that gaming event.

FIG. 17 is a flow diagram depicting a representative space travel methodology where an enhancement value(s) is applied across concurrently-played gaming events in a multi-play gaming activity.

FIG. 18 is a flow diagram depicting a representative space travel methodology where an enhancement value(s) is applied across discrete payout areas in a common gaming event.

### DETAILED DESCRIPTION

In the following description of various exemplary embodiments, reference is made to the accompanying drawings which form a part hereof, and in which is shown by way of illustration representative embodiments in which the features described herein may be practiced. It is to be understood that other embodiments may be utilized, as structural and operational changes may be made without departing from the scope of the disclosure.

In the description that follows, the terms “reels,” “cards,” “decks,” and similar mechanically descriptive language may be used to describe various apparatus presentation features, as well as various actions occurring to those objects (e.g., “spin,” “draw,” “hold,” “bet”). Although the present disclosure may be applicable to manual, mechanical, and/or computerized embodiments, as well as any combination therebetween, the use of mechanically descriptive terms is not meant to be only applicable to mechanical embodiments. Those skilled in the art will understand that, for purposes of providing gaming experiences to players, mechanical elements such as cards, reels, and the like may be simulated on a display in order to provide a familiar and satisfying experience that emulates the behavior of mechanical objects, as well as emulating actions that occur in the non-computerized games (e.g., spinning, holding, drawing, betting). Further, the computerized version may provide the look of mechanical equivalents but may be generally randomized in a different way. Thus, the terms “cards,” “decks,” “reels,” “hands,” etc., are intended to describe both physical objects and emulation or simulations of those objects and their behaviors using electronic apparatuses.

In various embodiments, the gaming displays are described in conjunction with the use of data in the form of “symbols.” in the context of this disclosure, a “symbol” may generally refer at least to a collection of one or more arbitrary indicia or signs that have some conventional or defined significance. In particular, the symbol may represent values that can at least be used to determine whether to award a payout. A symbol may include numbers, letters, shapes, pictures, textures, colors, sounds, etc., and any combination therebetween. A play state, such as a win, can be determined by comparing the symbol with one or more other symbols. Such comparisons can be performed, for example, via software by mapping numbers (or other data structures such as character strings) to the symbols and performing the comparisons on the numbers/data structures. Other conventions associated with known games (e.g., the numerical value/ordering of face cards and aces in card games) may also be programmatically analyzed to determine winning combinations.

Generally, systems, apparatuses and methods are described for using enhancement values, such as multipliers, in different games from when they are triggered or otherwise originate in gaming activities. The systems, apparatuses and methods described herein may be implemented as a single game, or part of a multi-part game. For example, the game features described herein may be implemented in primary gaming activities, bonus games, side bet games or other secondary games associated with a primary gaming activity. The game features may be implemented in stand-alone games, multi-player games, etc. Further, the disclosure may be applied to games of chance, and descriptions provided in the context of any representative game (e.g. slot game) is provided for purposes of facilitating an understanding of the features described herein. However, the principles described herein are equally applicable to any game of chance where an outcome(s) is determined for use in the player's gaming activity.

Embodiments of the present concept include providing gaming devices (also referred to as gaming apparatuses or gaming machines), gaming systems, and methods of operating these devices or systems to provide game play that utilizes operations of using multipliers or other value or payout enhancers in different games or game events from which they arise. In one embodiment, a method of operating a gaming device includes determining whether a multiplier trigger is satisfied and determining whether a current game outcome is associated with an award meeting a predefined threshold, or an award at all. In one illustrative embodiment, if a multiplier or other payout enhancement value(s) is triggered, but the current game outcome is not associated with an award (or not associated with an award meeting some predefined threshold), the multiplier travels back in time to a previous win (or previous win meeting a predefined threshold) to augment (e.g., multiply with) that previous award. In other embodiments, if a multiplier is triggered, but the current game outcome meets some criteria (e.g., is not associated with an award), the multiplier is saved for the next game outcome associated with an award or an award above a predefined threshold.

Numerous variations are possible in view of these and other embodiments of the inventive concept. Some of these embodiments and variations are discussed below with reference to the drawings. However, many other embodiments and variations exist that are covered by the principles and scope of this concept. For example, although some of the embodiments discussed below involve reel-based slot machine examples of this concept, other embodiments include application of these inventive techniques in other types of slot games, poker games, roulette, bingo, or other games of chance. Some of these other types of embodiments will be discussed below as variations to the examples illustrated. However, many other types of games can implement similar techniques and fall within the scope of this inventive concept.

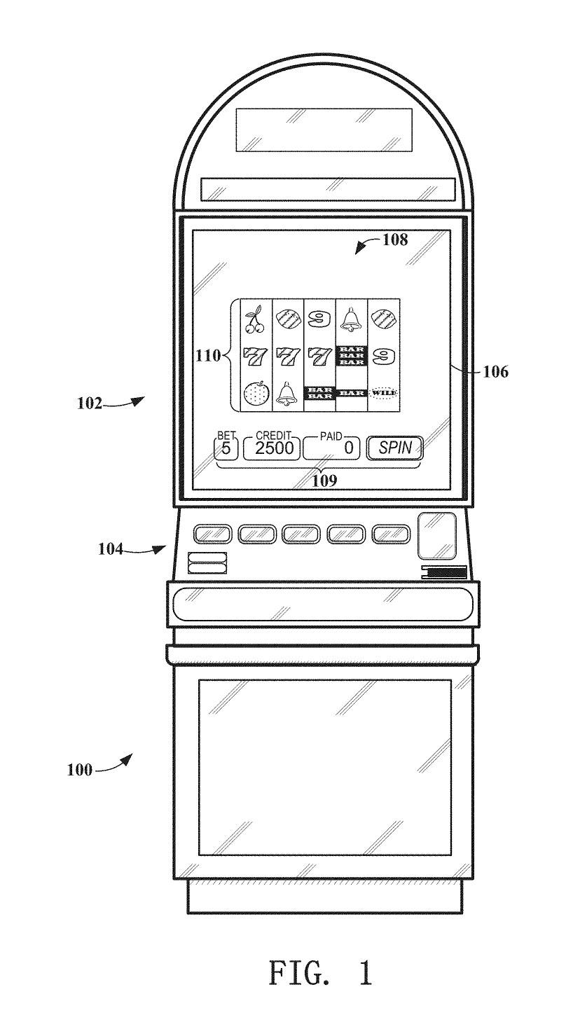

Referring to the example gaming apparatus 100 shown in FIG. 1, the representative gaming apparatus includes at least a display area(s) 102 (also referred to as a gaming display), and a player interface area(s) 104, although some or all of the interactive mechanisms included in the user interface area 104 may be provided via other or additional means, such as graphical icons used with a touch screen in the display area 102 in some embodiments. The display area 102 may include one or more game displays 106 (also referred to as “displays” or “gaming displays”) that may be included in physically separate displays or as portions of a common large display. Here, the representative game display 106 includes at least a primary game play portion 108 that displays game elements and symbols 110, and an operations portion 109 that can include meters, various game buttons and other input mechanisms, and/or other game information for a player of the gaming device 100.

The user interface 104 allows the user to control, and engage in play of, and otherwise interact with the gaming machine 100. The particular user interface mechanisms included with user interface 104 may be dependent on the type of gaming device. For example, the user interface 104 may include one or more buttons, switches, joysticks, levers, pull-down handles, trackballs, voice-activated input, touch screen input, tactile input, and/or any other user input system or mechanism that allows the user to play and interact with the particular gaming activity.

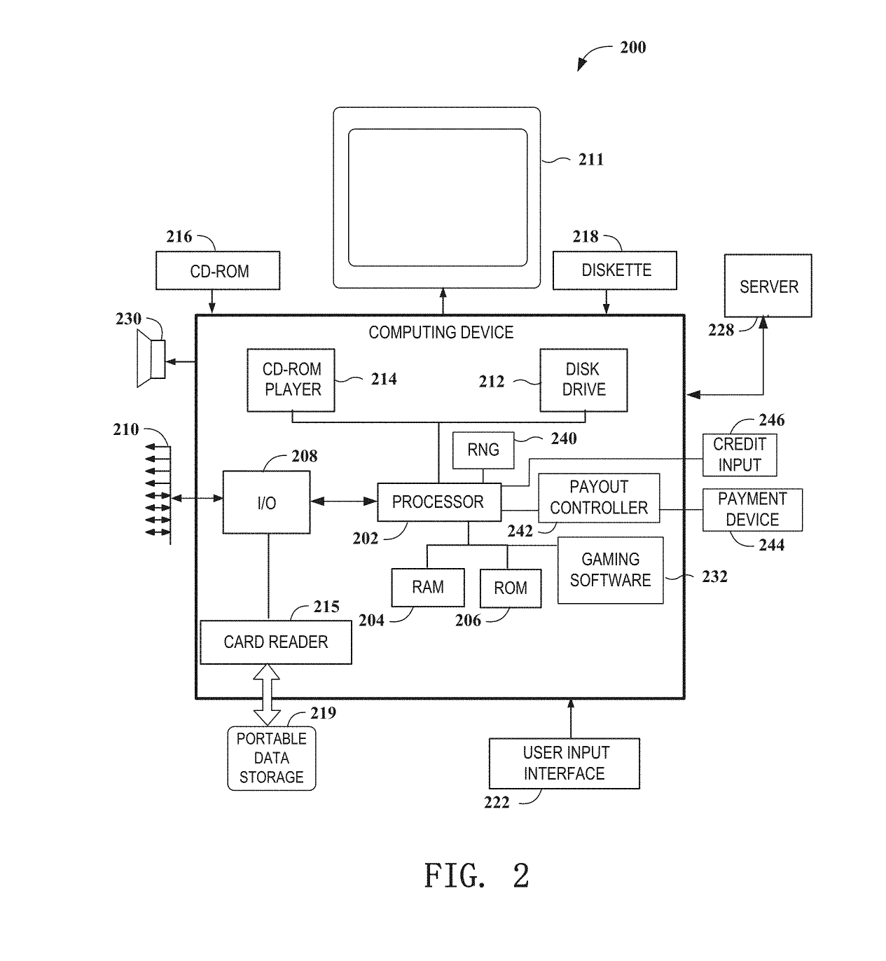

The user interface 104 may allow the user or player to enter coins, bills, or otherwise obtain credits through vouchers, tokens, credit cards, tickets, electronic money, etc. Various mechanisms for entering such vouchers, tokens, credit cards, coins, tickets, etc. are described below with reference to FIG. 2. For example, currency input mechanisms, card readers, credit card readers, smart card readers, punch card readers, radio frequency identifier (RFID) readers, and other mechanisms may be used to enter wagers. The user interface 104 may also include a mechanism to read and/or validate player information, such as player loyalty information, to identify a user or player of the gaming device. This mechanism may be, for example, a card reader, biometric scanner, keypad, or other input device. It is through a user interface such as the user interface 104 that the player can initiate and engage in gaming activities. While the illustrated embodiment depicts various buttons for the user interface 104, it should be recognized that a wide variety of user interface options are available for use in connection with the present invention, including pressing buttons, touching a segment of a touch-screen, entering text, entering voice commands, or other known data entry methodology.

The game display 106 in the display area 102 may include one or more of an electronic display, a video display, a mechanical display, and fixed display information, such as paytable information associated with a glass/plastic panel(s) on the gaming machine 100 and/or graphical images. The symbols or other indicia associated with the play of the game may be presented on an electronic display device or on mechanical devices associated with a mechanical display. In some embodiments, the display 106 devotes the largest portion of viewable area to the primary gaming portion 108. The primary gaming portion 108 may provide visual feedback to the user for any selected game. The primary gaming portion 108 may render graphical objects such as cards, slot reels, dice, animated characters, and any other gaming visual known in the art. The primary gaming portion 108 may also inform players of the outcome of any particular event, including whether the event resulted in a win or loss.

In some example embodiments illustrated herein, the primary gaming portion 108 may display a grid (or equivalent arrangement) of game elements 110 or game element positions (also referred to herein as “reel stop positions”). As illustrated in the embodiment shown in FIG. 1, the grid includes three rows and five columns of game elements 110, which may form a game outcome(s) of a game play event from which prizes are determined. In some slot machine examples, each column may display a portion of a game reel. The game reels may include a combination of game symbols in a predefined order. In mechanical examples, the game reels may include physical reel strips where game symbols are shown in images fixed on the reel strips. Virtual reel strips may be mapped to these physical reel positions shown on the reel strips to expand the range or diversity of game outcomes. In video slot examples, reel strips may be encoded in a memory or database and virtual reels may be used for the game reels with images representing the data related to the reel strips. In other slot machine embodiments, each reel stop position on the grid may be associated with an independent reel strip. In yet other slot machine embodiments, reels and/or reel strips may not be used at all in determining the symbols shown in the game element positions of the grid. For example, a symbol may be randomly selected for each game element position, or the symbols may be determined in part by game events occurring during game play, such as displayed elements being replaced by new game elements or symbols. Numerous variations are possible for implementing slot-type game play.

The primary gaming portion 108 may include other features known in the art that facilitate gaming, such as status and control portion 109. As is generally known in the art, this portion 109 provides information about current bets, current wins, remaining credits, etc. associated with gaming activities of the grid of game elements 110. The control portion 109 may also provide touchscreen controls for facilitating game play. The grid of game elements 110 may also include touchscreen features, such as facilitating selection of individual symbols, or user controls over stopping or spinning reels. The game display 106 of the display area 102 may include other features that are not shown, such as paytables, navigation controls, etc.

Although FIG. 1 illustrates a particular implementation of some of the embodiments of this invention in a casino or electronic gaming machine (“EGM”), one or more devices may be programmed to play various embodiments of the invention. The concepts and embodiments described herein may be implemented, as shown in FIG. 1, as a casino gaming machine or other special purpose gaming kiosk as described herein, or may be implemented via computing systems operating under the direction of local gaming software, and/or remotely-provided software such as provided by an application service provider (ASP). Casino gaming machines may also utilize computing systems to control and manage the gaming activity, although these computing systems typically include specialized components and/or functionality to operate the particular elements of casino gaming machines. Additionally, computing systems operating over networks, such as the Internet, may also include specialized components and/or functionality to operate elements particular to these systems, such as random number generators. An example of a representative computing system capable of carrying out operations in accordance with the principles described herein is illustrated in FIG. 2.

Hardware, firmware, software or any combination thereof may be used to perform the various gaming functions, display presentations and operations described herein. The functional modules used in connection with the disclosure may reside in a gaming machine as described, or may alternatively reside on a stand-alone or networked computer. The representative computing structure 200 of FIG. 2 is an example computing structure that can be used in connection with such electronic gaming machines, computers, or other computer-implemented devices to carry out operations of the present invention. Although numerous components or elements are shown as part of this computing structure 200 in FIG. 2, additional or fewer components may be utilized in particular implementations of embodiments of the invention.

The example computing arrangement 200 suitable for performing the gaming functions described herein includes a processor, such as depicted by the representative central processing unit (CPU) 202, coupled to memory, such as random access memory (RAM) 204, and some variation of read-only memory (ROM) 206. The ROM 206 may also represent other types of storage media to store programs, such as programmable ROM (PROM), erasable PROM (EPROM) or any technology capable of storing data. The processor 202 may communicate with other internal and external components through input/output (I/O) circuitry 208 and bussing 210, to communicate control signals, communication signals, and the like.

The computing arrangement 200 may also include one or more data storage devices, including hard and floppy disk drives 212, CD-ROM drives 214, card reader 215, and other hardware capable of reading and/or storing information such as DVD, etc. In one embodiment, software for carrying out the operations in accordance with the present invention may be stored and distributed on a CD-ROM 216, diskette 218, access card 219, or other form of computer readable media capable of portably storing information. These storage media may be inserted into, and read by, devices such as the CD-ROM drive 214, the disk drive 212, card reader 215, etc. The software may also be transmitted to the computing arrangement 200 via data signals, such as being downloaded electronically via a network, such as local area network (casino, property, or bank network) or a wide area network (e.g., the Internet). Further, as previously described, the software for carrying out the functions associated with the present invention may alternatively be stored in internal memory/storage of the computing device 200, such as in the ROM 206.

The computing arrangement 200 is coupled to one or more displays 211, which represent a manner in which the gaming activities may be presented. The display 211 represents the “presentation” of the game information in accordance with the disclosure, and may be a mechanical display showing physical spinning reels, a video display, such as liquid crystal displays, plasma displays, cathode ray tubes (CRT), digital light processing (DLP) displays, liquid crystal on silicon (LCOS) displays, etc., or any type of known display or presentation screen.

Where the computing device 200 represents a stand-alone or networked computer, the display 211 may represent a standard computer terminal or display capable of displaying multiple windows, frames, etc. Where the computing device 200 represents a mobile electronic device, the display 211 may represent the video display of the mobile electronic device. Where the computing device 200 is embedded within an electronic gaming machine, the display 211 corresponds to the display screen of the gaming machine/kiosk.

A user input interface 222 such as a mouse, keyboard/keypad, microphone, touch pad, trackball, joystick, touch screen, voice-recognition system, card reader, biometric scanner, RFID detector, etc. may be provided. The user input interface 222 may be used to input commands in the computing arrangement 200, such as placing wagers or initiating gaming events on the computing arrangement 200, inputting currency or other payment information to establish a credit amount or wager amount, inputting data to identify a player for a player loyalty system, etc. The display 211 may also act as a user input device, e.g., where the display 211 is a touchscreen device. In embodiments, where the computing device 200 is implemented in a personal computer, tablet, smart phone, or other consumer electronic device, the user interface and display may be the available input/output mechanisms related to those devices.

Chance-based gaming systems such as slot machines, in which the present invention is applicable, are governed by random numbers and processors, as facilitated by a random number generator (RNG) or other random generator. The fixed and dynamic symbols generated as part of a gaming activity may be produced using one or more RNGs. RNGs may be implemented using hardware, software operable in connection with the processor 202, or some combination of hardware and software. The principles described herein are operable using any known RNG, and may be integrally programmed as part of the processor 202 operation, or alternatively may be a separate RNG controller 240 which may be associated with the computing arrangement 200 or otherwise accessible such as via a network. The RNGs are often protected by one or more security measures to prevent tampering, such as by using secured circuitry, locks on the physical game cabinet, and/or remote circuitry that transmits data to the gaming device.

The computing arrangement 200 may be connected to other computing devices or gaming machines, such as via a network. The computing arrangement 200 may be connected to a network server(s) 228 in an intranet or local network configuration. The computer may further be part of a larger network configuration as in a global area network (GAN) such as the Internet. In such a case, the computer may have access to one or more web servers via the Internet. In other arrangements, the computing arrangement 200 may be configured as an Internet server and software for carrying out the operations in accordance with the present invention may interact with the player via one or more networks. The computing arrangement 200 may also be operable over a social network or other network environment that may or may not regulate the wagering and/or gaming activity associated with gaming events played on the computing arrangement.

Other components directed to gaming machine implementations include manners of gaming participant payment, and gaming machine payout. For example, a gaming machine including the computing arrangement 200 may also include a payout controller 242 to receive a signal from the processor 202 or other processor(s) indicating a payout is to made to a player and controlling a payout device 244 to facilitate payment of the payout to the player. In some embodiments, the payout controller 242 may independently determine the amount of payout to be provided to the participant or player. In other embodiments, the payout controller 242 may be integrally implemented with the processor 202. The payout controller 242 may be a hopper controller, a print driver, credit-transmitting device, bill-dispensing controller, accounting software, or other controller device configured to verify and/or facilitate payment to a player.

A payout or payment device 244 may also be provided in gaming machine embodiments, where the payment device 244 serves as the mechanism providing the payout to the player or participant. In some embodiments, the payment device 244 may be a hopper, where the hopper serves as the mechanism holding the coins/tokens of the machine, and/or distributing the coins/tokens to the player in response to a signal from the payout controller 242. In other embodiments, the payout device 244 may be a printer mechanism structured to print credit-based tickets that may be redeemed by the player for cash, credit, or other casino value-based currency or asset. In yet other embodiments, the payout device 244 may send a signal via the network server 228 or other device to electronically provide a credit amount to an account associated with the player, such as a credit card account or player loyalty account. The computing arrangement 200 may also include accounting data stored in one of the memory devices 204, 206. This accounting data may be transmitted to a casino accounting network or other network to manage accounting statistics for the computing arrangement or to provide verification data for the currency or currency-based tickets distributed by the payout device, such as providing the data associated with the bar codes printed on the currency-based tickets so they are identifiable as valid tickets for a particular amount when the player redeems them or inserts them in another gaming device.

The wager input module or device 246 represents any mechanism for accepting coins, tokens, coupons, bills, electronic fund transfer (EFT), tickets, credit cards, smart cards, membership/loyalty cards, etc., for which a participant inputs a wager amount. The wager input device 246 may include magnetic strip readers, bar code scanners, light sensors, or other detection devices to identify and validate physical currency, currency-based tickets, cards with magnetized-strips, or other medium inputted into the wager input device. When a particular medium is received in the wager input device 246, a signal may be generated to establish or increase an available credit amount or balance stored in the internal memory/storage of the computing device 200, such as in the RAM 204. Thereafter, specific wagers placed on games may reduce the available credit amount, while awards won may increase the available credit amount. It will be appreciated that the primary gaming software 232 may be able to control payouts via the payment device 244 and payout controller 242 for independently determined payout events.

Among other functions, the computing arrangement 200 provides an interactive experience to players via an input interface 222 and output devices, such as the display 211, speaker 230, etc. These experiences are generally controlled by gaming software 232 that controls a primary gaming activity of the computing arrangement 200. The gaming software 232 may be temporarily loaded into RAM 204, and may be stored locally using any combination of ROM 206, drives 212, media player 214, or other computer-readable storage media known in the art. The primary gaming software 232 may also be accessed remotely, such as via the server 228 or the Internet.

The primary gaming software 232 in the computing arrangement 200 may be an application software module. According to embodiments of the present invention, this software 232 provides a slot game or similar game of chance as described herein. For example, the software 232 may present, by way of the display 211, representations of symbols to map or otherwise display as part of a slot based game having reels. However, in other embodiments, the principles of this concept may be applied to poker games or other types of games of chance. One or more aligned positions of these game elements may be evaluated to determine awards based on a paytable. The software 232 may include instructions to provide other functionality as known in the art or as described and shown herein.

As described above, in some embodiments, on any spin or other game event, there is a chance that a multiplier or other value enhancer is generated. In a slot embodiment where the enhancement value is a multiplier, if the spin results in a win, the multiplier is applied to that win. However, in one embodiment, if that spin does not result in a win, a “time travel” event may occur taking the player back to a previous winning spin(s) or other gaming event(s), and apply the multiplier to that win. For example, the time travel event may apply a currently received multiplier to the most recent, previous win. In other embodiments, the multiplier or other value enhancer may be kept or banked for the next gaming outcome that is associated with a winning outcome.

In some of these embodiments, this may generate a situation where when a player gets a large win without a multiplier trigger, they are hoping to get a “time travel” multiplier in a subsequent gaming event before they get a smaller win. In some embodiments, there could be a limit on the number of games that can the “time travel” multiplier can be applied to. In other embodiments, there may be a time limit or other condition on which the time travel enhancement value is made available. Additionally, if a cashout command is received, or a player loyalty card is removed, the ability to use a “time travel” multiplier may be eliminated.

In other embodiments, the “time travel” multiplier could be applied to the larger of the current win or some past win, or could be applied to both. In some embodiments, the “time travel” multiplier may only apply to wins of certain types (i.e. high symbols), natural symbol wins, line wins, scatter wins, etc.

In some embodiments that use multiple game grids in one gaming event (i.e., a wager covers play on multiple different game grids), a “space travel” multiplier triggered on one of the played game grids, may be applied to the game grid with the best outcome. In other embodiments, aspects of the “time travel” multiplier and “space travel” multiplier may be combined so that the best previous award within the multiple game grids is multiplied by a triggered game multiplier.

In yet other embodiments, instead of applying a triggered multiplier to the previous win, or next win, multiplier windows are created using, for example, one or the following groupings:

Forward 5

Forward 10

Forward 25

Forward 50

Forward 100

Forward X

Back 5

Back 10

Back 25

Back 50

Back 100

Back Y

In this embodiment, to open a Forward Window, a random event (Mystery, sub-symbol, etc.) occurs during a spin. In this embodiment, a Forward Window is defined by its duration and multiplier, and will stay active for the # of spins specified in its duration. For example a Forward 5 Window would stay active for the next 5 spins. During that window, the game will track a desired game condition, such as the total win the player achieves during the open window; the highest individual pay during the open window; the average pay during the open window; random selection of one or more individual pays during the open window; or any other desired criteria for selecting the game event outcome during the open window in which to apply the multiplier or other enhancement value. In one embodiment, when the window closes, the highest win achieved while the window was open has the Forward Window multiplier applied to it. For example, a player triggers a Forward 5 window with a 6× multiplier. The next 5 spin results are as follows:

0
20
0
200
5

In this embodiment, the highest win occurring in the window is 200, which would be multiplied by 6 and awarded to the player. In other embodiments, the total wins during the open window (e.g., 225 in this illustrated embodiment) may be multiplied by the 6× multiplier. In still other embodiments, an average win during the open window (e.g., 45 in this illustrated embodiment) may be multiplied by the 6× multiplier. In yet other embodiments, a random selection of one or more of the payouts during the open window may be selected (e.g., randomly select spins 2 and 5, to total 25 in the illustrated example). These and other criteria may be utilized to select one or more of the payment amounts during the open window to apply to the enhancement value available to that open window.

In another embodiment employing a forward time travel enhancement value, the multiplier or other modifier may be applied to a known number or random number of future spins or other game events. For example, the multiplier or other value enhancer may be set to be applied to the third future game event that produces a non-zero result, or in other embodiments merely applied to the third future game event regardless of whether it is a zero or non-zero result. In another embodiment, the multiplier or other value enhancer may be applied to the n^{th} future game event that produces a non-zero result, or in other embodiments merely applied to the n^{th} future game event regardless of whether it is a zero or non-zero result.

In another embodiment, the trigger to enable the time or space travel itself can be based on time or duration (e.g., the last five events), and/or may be based on events occurring. For example, an event(s) may serve as a trigger, such as a particular symbol combination, occurrence of a bonus event, payout with a threshold value, etc. Thus, the triggering event may be time-based, event-based, condition-based, etc. For example, in an embodiment employing a forward time travel enhancement value, the multiplier or other modifier may be applied to a future game event that meets some criteria that serves as a trigger to cause the multiplier to be applied, such as that future game event having a payout relative to a threshold, an awarded bonus event, a free spin/play event, and/or any other criteria. Thus, rather than an embodiment where the nth future event serves as a trigger, other triggers can be used versus a time or count value.

Such event-based triggers can also be used for backwards time travel, where the “window” involves one or more prior events that meet some criteria. For example, a current event result may be a payout of 50 credits which can be paid, but meeting that 50-credit threshold may enable that same payout to be multiplied by a future enhancement value. Any desired criteria may be used.

In other embodiments, one or more separate “buckets” of event results may be used instead of or in addition to durational windows (e.g., the next 5 spins). This may involve storing or otherwise associating certain event occurrences for use at a future (or past) time. For example, one event result may be stored for future application with an enhancement value(s) where the gaming result achieved some pay type, such as a minimum or maximum amount, a particular symbol combination(s), results involving a particular symbol(s), a scatter pay, a bonus play, a progressive jackpot, the next full-row symbol win, etc. In one embodiment, multiple, or all, of such event results meeting the desired criteria may be stored (e.g., placed in a virtual “bucket”) for applicability with a future enhancement value, where one, more, or all of the events in the bucket are impacted by the future enhancement value.

In other embodiments, multiple “buckets” may be used to store events of similar types, and one or more of the buckets may be chosen (randomly, or via some selection/criteria process) to be used with a time-offset enhancement value(s). For example, one bucket may include payouts reaching a certain minimum value, and another bucket may store yet-to-be-known payout results such as a bonus play that is stored for use with a subsequently-awarded enhancement value. In one embodiment, all buckets may be used with the subsequent (or past) enhancement value, where in other embodiments a particular bucket is randomly chosen or chosen due to some criteria being met. All of the events in the selected bucket(s) may be enhanced with the subsequent enhancement value, or some subset thereof (e.g., a randomly selected one or more; the highest value; the average value; the lowest value; the sum of all values; etc.).

In other embodiments, there may be an option for the player to cash out an accumulated Forward Window values for a credit award.

To open a Backwards Window in one embodiment, a random event (Mystery, sub-symbol, etc.) occurs during a spin. Other manners of obtaining such a window are also contemplated, such as purchasing such an opportunity, trading other winning results or player assets, etc. A Backwards Window may be defined by its duration and multiplier. In one embodiment, unlike Forward Windows, Backwards Windows are always visible but are normally not active, although in other embodiments the Backwards Windows need not be made visible even though the values may be known.

An example set of Backward Windows is shown below

| | |
|---|---|
| Back 5 | 10 |
| Back 10 | 10 |
| Back 25 | 50 |
| Back 50 | 100 |
| Back 100 | 350 |

In one embodiment, each window shows the largest win that occurred in the previous N spins where N is the number associated with the window. Upon triggering, the player is presented with a Backwards Window description that pairs a multiplier with the specific window. The multiplier is then applied to the corresponding win and awarded to the player.

For example, using the Backwards Window table above, the player places a bet and receives a Backwards Window 50 multiplier of 3×. The Back 50 value is 100 credits, which is multiplied by 3 and awarded to the player. The Backward Windows table/information may be presented to and known in advance to the player, or may be hidden and the table or just the awarded window made known to the player upon receiving the Backwards Window award.

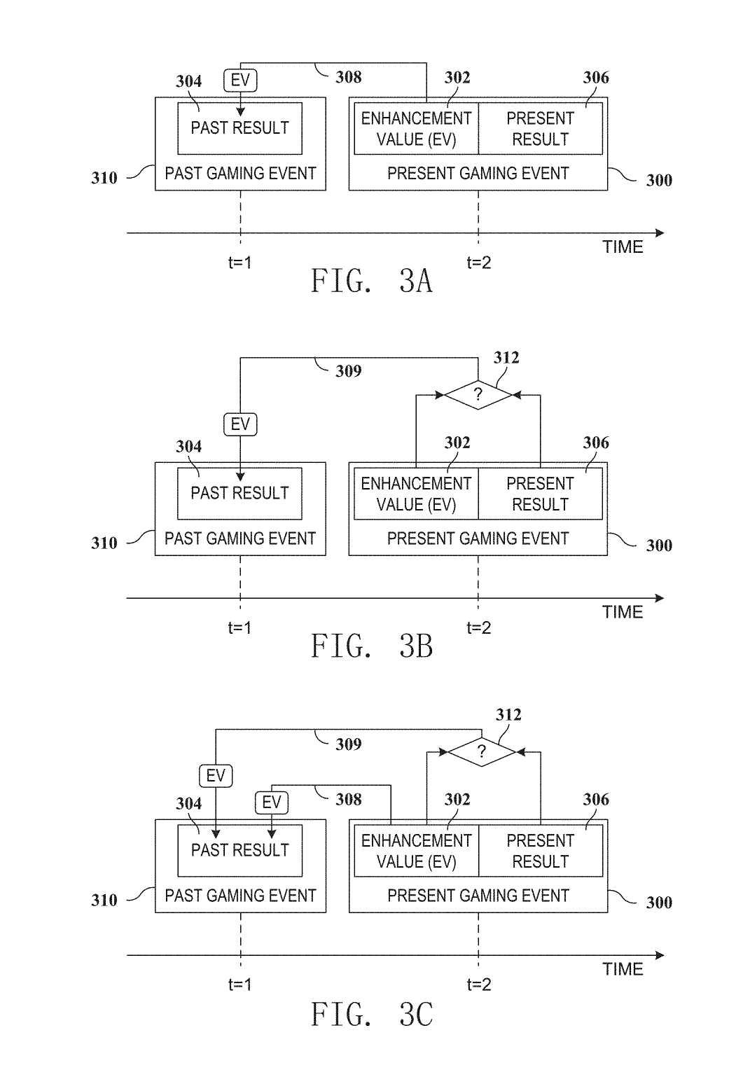

As described above, embodiments of the present disclosure include traveling in time, such as backward or forward through a sequence of events, to apply an enhancement value to an award occurring at a different time. FIG. 3A is a block diagram depicting one such embodiment, where an enhancement value (EV) 302 of a gaming event 300 travels back in time to be applied to a past result 304 or other outcome of a past gaming event 310. An enhancement value or modifier as used herein may be a single value or multiple values.

In the example of FIG. 3A, the present gaming event 300 occurs at time t=2. The present gaming event 300 may be for example a reel spin in a slot game, a dealt hand in a card game, a spin in a roulette game, etc. In this example, a present result 306 occurs as a result of participating in the present gaming event 300. For example, a concluding set of symbols on a real spin may represent the present result 306, which may or may not include one or more winning outcomes resulting in an award paid out to the participant.

The enhancement value (EV) 302 represents some occurrence that will impact a payout. For example, the enhancement value 302 may increase or otherwise augment a payout occurring in the game in which the present gaming event 300 is part of. In one embodiment, a multiplier represents the enhancement value 302, such that if an award, payout or other player asset is awarded in the present gaming event 300, the enhancement value 302 amplifies or otherwise augments that award, payout or other player asset. The enhancement values described herein may be represented by any number of value enhancing functions, such as multiplication, addition, exponentiation, etc. In other embodiments, the value enhancement values may even be represented by converse enhancement functions such as subtraction or division—e.g., where a game may reduce a presently-received enhancement value 302 as a consequence of applying it to a past or future gaming event result.

In accordance with the principles described herein, the enhancement value 302 instead (or additionally) augments a different gaming event than that from which the enhancement value 302 originated. In the example of FIG. 3A, the enhancement value 302 is used to augment a past result 304 associated with the past gaming event 310, as depicted by line 308. The enhancement value (EV) 302 travels back in time, such as to a gaming event that occurred at an earlier time t=1, in order to enhance the past result 304 and award the updated total to the player. In one embodiment, the past result 304 to which the enhancement value 302 is applied is the most recent winning result. In other embodiments, the enhancement value 302 is applied to the most recent past result 304, regardless of whether it resulted in a winning (i.e., non-zero, positive player asset) result or not. In yet other embodiments, the past result 304 may be a set number of results in the past (e.g., ten past gaming events 310 ago, or five winning past results 304 ago), or may apply to a past result 304 from a random number of past gaming events 310 or a random number of past results 304. It should be noted that, as used herein, traveling back in time may refer to traveling to a prior gaming event 310 in a sequence of events, even if the actual “time” between gaming events is small or negligible (e.g., a plurality of gaming events are presented in a sequence at substantially the same time). Thus, the enhancement value 302 is applied to a prior result 304 that occurred previously in sequence and/or time. The past gaming event 310 may be the same type of gaming event as the present gaming event 300, such as both being slot games, or both being poker games, etc. Alternatively, the past gaming event 310 may be of a different type of gaming event as the present gaming event 300, such as one being a slot game and one being a poker game, or any combination of games such as slot games, poker/blackjack/card games, bingo, poker, random events such as wheel spins, etc. Thus, the enhancement value 302 can be applied to any past result 304 associated with any same or different past gaming event 310.

A representative example is described in the context of slot games, although the principles are equally applicable to other wagering or non-wagering games involving discreet gaming events (e.g., spins, hands, bingo plays, keno events, etc.). The present gaining event 300 may be implemented as a reel spin in a slot game, where the symbols on multiple physical or virtual reels are randomized to present a pattern of the symbols on the reels presented via a display device(s). If the symbol pattern results in symbol paylines that correspond to payouts (i.e., winning paylines), the present result 306 may be a non-zero outcome in favor of the player. In other instances, the present result 306 may be zero (i.e., no win), or in some cases even a negative number. If an enhancement value 302 such as a multiplier is awarded during play of the present slot game 300, that multiplier 302 is applied to a prior slot game 310 (in time and/or sequence) that has already occurred, and which already resulted in some past result 304 (which may be zero, or some non-zero result). As a more particular example, the enhancement value 302 may be a 5× multiplier that is applied to a 50-credit win (past result 304) in a past gaming event 310, thereby augmenting the past result 304 from a 50-credit win to a 250-credit win (50 credits×5).

In some embodiments, there may be rules to determine when such enhancement value 302 can be applied to a past result 304 of the past gaming event 310. An example is depicted in FIG. 3B. This example enables an enhancement value 302 to be applied to a past result 304, but only when some condition(s) or rule(s) has been met. For example, a condition 312 determining whether the present result 306 was zero (i.e., the present result 306 did not result in a winning payout) may serve as a condition to allow the enhancement value 302 to be applied to a prior result. As a more particular example, if in a present slot game 300 the present result 306 is zero, and an enhancement value 302 was awarded, the enhancement value 302 may be applied to a past result 304 of a past gaming event 310. This is depicted by the enhancement value 302 being conditionally applied to the past result 304 via line 309. In one embodiment, such a rule is applied so that the enhancement value 302 is not wasted on a non-winning present result 306. Other conditions 312 may instead or additionally be used, such as whether the present result 306 reached a threshold, or a “streak” of non-winning (or low winning) payouts occurred, or a random event or count materialized, or a special symbol or feature occurred, etc. Thus, the embodiment of FIG. 3B generally depicts a manner of applying an enhancement value 302 to a past result 304 if a certain condition(s) 312 occurs, such as some event or result occurring in connection with the present gaming event 300.

In another embodiment depicted in FIG. 3C, the enhancement value 302 may be applied to both a past result(s) 304 due to meeting some condition 312 relating to a present result 306 as depicted via line 309, and/or to an event unrelated to the present result 306. For example, one embodiment involves conditioning the application of the enhancement value 302 to a past result(s) 304 when the present result 306 is a non-winning result (depicted by line 309), while additionally allowing random or other applications of the enhancement value 302 to a past result(s) 304 regardless of the present result 306 (depicted by line 308).

Other embodiments may involve applying the enhancement value 302 to any past result 304, which may be one or more of the most recent past results, or one or more past results from any point in the past. In one embodiment, past results can be marked or otherwise designated as available for subsequent use with enhancement values as described herein. For example, certain past results can be randomly marked, marked based on condition (e.g., a past result having at least twenty credits), marked based on time, etc. In this manner, event type buckets may be used instead of (or in addition to) windows of some number of events (e.g., the last 5 reel slot spins). One or more gaming result types may be collectively or separately stored for use with subsequently-awarded enhancement values 302. For example, a virtual “bucket” of one or more events meeting a symbol-related criteria may be used, such as those gaming event results filling an entire payline (e.g., a 5-pay symbol combination on a 5-reel game), and/or results of a particular symbol (e.g., the highest value symbol), and/or result types (e.g., scatter pays, bonus plays), etc.

In other embodiments, the enhancement value 302 may be applied to the present result 306 in addition to being applied to a past result 304. In such an embodiment, a total award may include present result 306 as augmented by the enhancement value 302, plus a past result 304 as augmented by the enhancement value 302.

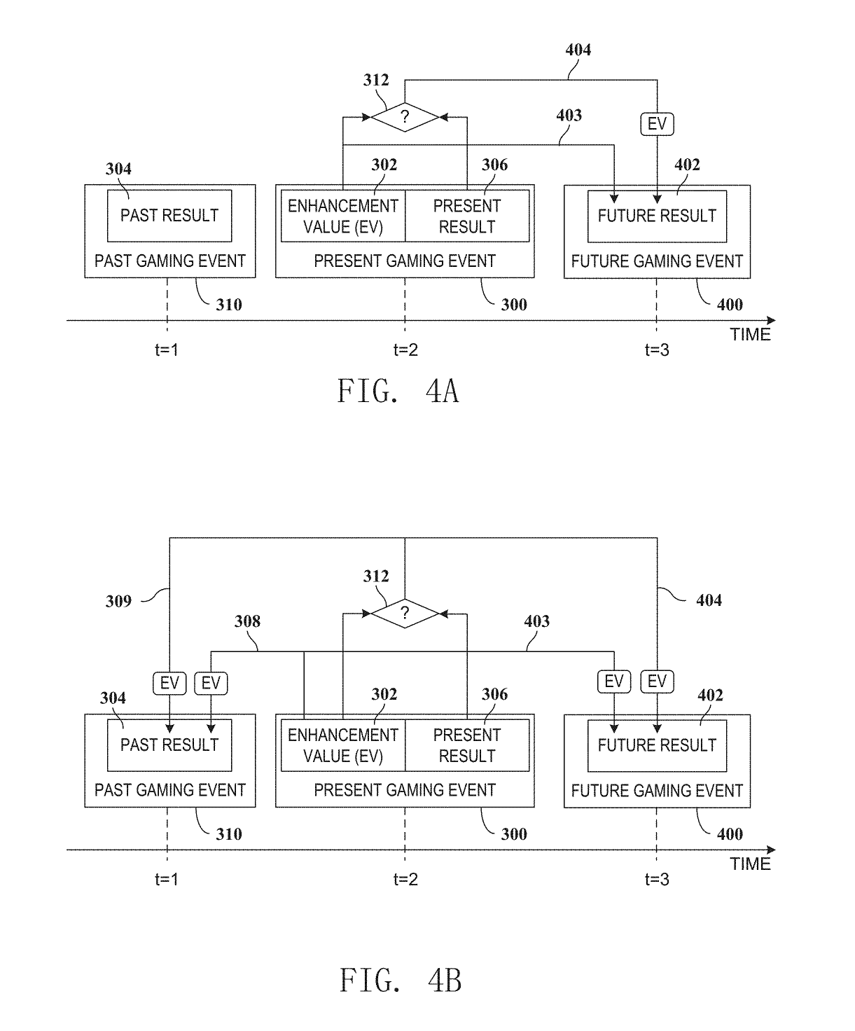

The embodiments described above are also applicable in embodiments where the application of the enhancement value to a gaming event other than the gaming event in which the enhancement value originated travels differently in time and/or space. For example, the enhancement value(s) may be applied to a future result of a future gaming event, such as depicted in FIG. 4A. In the example of FIG. 4A, events occurring in time or sequence are shown along a time continuum shown as TIME, with the present gaming event 300 occurring at an intermediate time, t=2. A past gaming event 310 occurred at time t=1, and a future gaming event 400 is depicted as occurring at time t=3. In this representative example, a past result 304 is depicted as occurring in connection with the past gaming event 310, and any one or more such past gaming events 310 may have occurred prior to the present gaming event 300. Additionally, a future result 402 is depicted as occurring in connection with the future gaming event 400, and any one or more such future gaming events 400 may occur after the present gaming event 300.

In the illustrated example, of FIG. 4A, a present result(s) 306 may occur, which may be a zero or positive result (or even a negative result in some embodiments). In any event, an enhancement value (EV) 302 occurs in connection with the present gaming event 300, such as a multiplier or other feature or function capable of increasing or otherwise impacting a gaming result. The enhancement value 302 may be applied directly as depicted via line 403, without any rules or conditions, to a future result 402, such as to multiply with a future result 402 of the immediately ensuing future gaming event 400. This can be done in addition to, or in lieu of, the enhancement value 302 being applied to the present result 306. In one example, the enhancement value 302 may be applied to a future result 402 instead of, or in addition to, being applied to the present result 306 if the present result is, for example, zero or below some threshold.

In another embodiment which is depicted in FIG. 4A, a condition 312 is considered, where the enhancement value 302 of the present gaming event 300 is applied (as depicted via line 404) to a future result 402 of a future gaming event 400 if a condition is met, such as if the present result 306 is zero, or zero a predetermined number of times in a row, or zero a predetermined number of times out of a second predetermined number of attempts, or below a threshold, or any other predetermined criteria (including randomly).

In one representative embodiment of the FIG. 4A example, the condition 312 is that the present result 306 resulted in no win (i.e., the present result 306 is zero), and an enhancement value 302 is a 5× multiplier that occurred in connection with the present gaming event 300. Where the multiplier (enhancement value 302) occurs and the present result 306 did not result in a winning payout, the 5× multiplier is applied to a future result 402 as depicted via line 404, such as the next sequential gaming event 400 played in time/sequence. In another embodiment, the 5× multiplier is applied to the next non-zero future result 402 (i.e. the future gaming event 400 to which the multiplier/enhancement value 302 is applied to will be the next future result 402 that provides some positive winning payout value). For purposes of illustration, if the future result 402 is twenty (20) credits, and a 5× multiplier serving as the enhancement value 302 is applied to the future result 402, the total winning payout for that future gaming event would be one-hundred (100) credits (i.e. 5× multiplier multiplied by 20 credits).

In one embodiment, the future result 402 to which the prior-occurring enhancement value 302 occurred is based on predetermined criteria, such that the particular future result to which the multiplier is applied is not within the control of the player. This predetermined criteria provides the basis of the condition 312, such as if the present result 306 is zero, or zero a predetermined number of times in a row, or zero a predetermined number of times out of a second predetermined number of attempts, or is below a threshold, or involves any other predetermined criteria (including randomly). The predetermined criteria may also include conditions on which particular future result 402 the enhancement value 402 will be applied to, such as the immediately ensuing future result 402 (whether a winning/non-zero future result 402 or not), or the next future result 402 that results in a winning/non-zero result, or the n^{th} future result 402 (where “n” is known or in other embodiments randomly determined), etc.

Other embodiments involve combinations of the embodiments of FIGS. 3A-3C and FIG. 4A. For example, as depicted in FIG. 49, an enhancement value 302 associated with a present gaming event 300 can be applied to either or both of a past result 304 associated with the past gaming event 310 and a future result 402 associated with a future gaming event 400. In one embodiment, the enhancement value 302, such as a multiplier, may be applied directly to a past result 304 and/or future result 402 as depicted via lines 308 and 403 respectively. In another embodiment, the enhancement value 302, such as a multiplier, may be applied to the past result 304 and/or future result 402 as a conditioned event, as depicted by the condition 312 via lines 309, 404 respectively. The enhancement value 302 may therefore be applied to the past result 304 in a manner as previously described, and/or may be applied to the future result 402 in a manner as previously described. In some embodiments the capability of being applied to past and future results is available, and an operator can configure the gaming machine to operate with either past results 304 or future results 402 associated with past gaming events 310 and future gaming events 400 respectively. Or, such operator configuration may be made to enable the enhancement value 302 to be applied to either past gaming results 304 and future gaming results 402, depending on predetermined or random criteria. In yet another embodiment, application of the enhancement value 302 may be made to both the past result 304 and future result 402 concurrently, such that total awards from both past and future gaming events 310, 400 are impacted by the occurrence of an enhancement value 302.

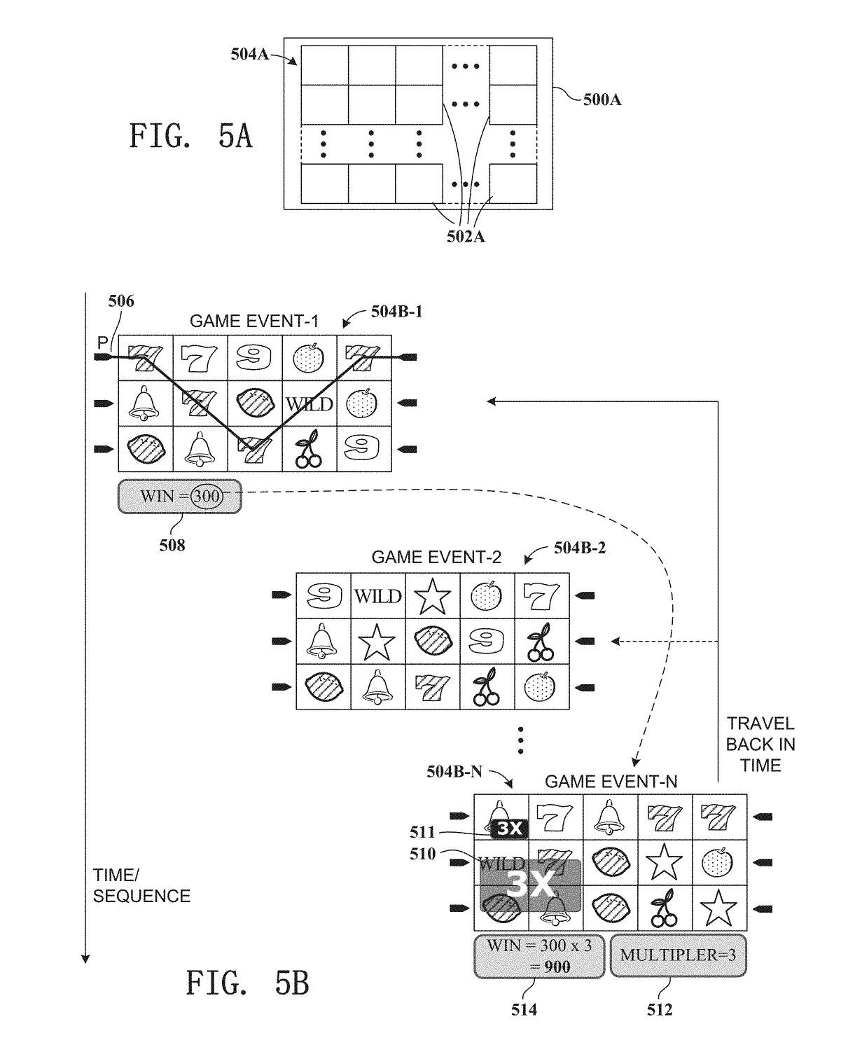

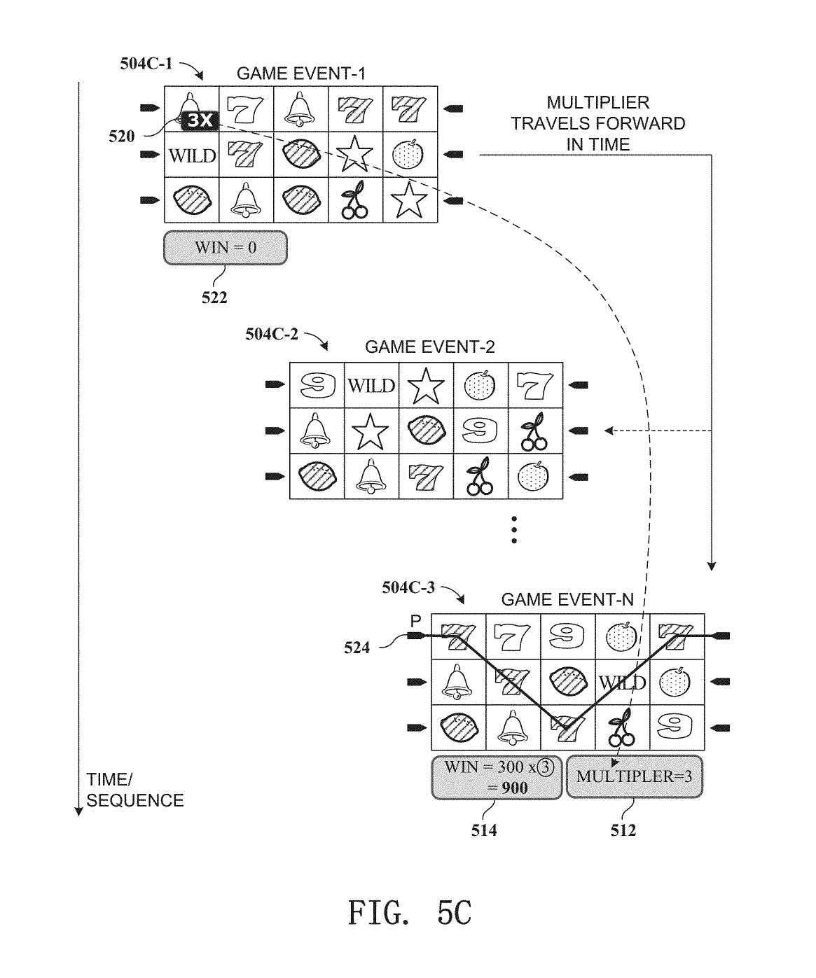

As noted herein, the gaming events that may be implemented in accordance with the present disclosure may be any desired gaming events, such as slot games, card games, roulette games, bingo games, keno games, etc. FIG. 5A depicts an exemplary slot game of indeterminate size in which the principles described herein are applicable. In the illustrated embodiment, the plurality of display segments 502 comprise a displayable grid 504 whereby symbols or other indicia may be presented on a display(s) 500 to determine symbol/indicia patterns that correspond to predetermined winning combinations of such symbols or other indicia (hereinafter referred to as “symbols,” encompassing any letters, words, numbers, symbols, or other visual or perceptible indicia unless otherwise noted). The display 500 may be a mechanical or other physical display, electronic display, and/or other presentation of such display segments 502 and corresponding symbols.

FIG. 5B depicts an example sequence of slot game events illustrating an embodiment of the time travel award enhancement described herein. The illustrated example depicts a plurality of sequential game events, shown as game event-1 that resulted in a pattern of presented symbols on display grid 504B-1 at a first time, game event-2 that resulted in a pattern of presented symbols on display grid 504B-2 at some second time (that may or may not immediately follow game event-1), and game event-N that resulted in a pattern of presented symbols on display grid 504B-N at some third time (that may or may not immediately follow game event-2).

As shown in game event-1, a plurality of symbols comprises the display grid 504B-1. For purposes of illustration, assume that obtaining a number of like symbols on a payline results in a positive payout back to the player, such as awarding some predetermined number of credits. In the illustrated example, assume that the player obtained five shaded seven symbols (including a wild symbol) on a payline (P) 506 that resulted in a payout of 300 credits at the first time. The payout amount may be displayed on the gaming display device, which may include one or more discreet gaming viewing units, as depicted at display area 508. In the illustrated example, the winning series of symbols occurred on payline P which includes the display segments at row-1/column-1, row-2/column-2, row-3/column-3, row-2/column-4, and row-1/column-5. One or more other payouts from other paylines could have also occurred. In the illustrated example of game event-1, the total payout from one or more winning paylines is 300 credits, from payline P 508.

The player continues to play the game, which results in subsequent gaining events, including game event-2 through game event-N. At various times throughout play, such as at random game events, a multiplier or other enhancement value may be awarded. In the example of FIG. 5B, the enhancement value is a 3× multiplier, meaning that some award can be enhanced by multiplying it by three (3). The multiplier or other enhancement value can be presented in any desired fashion or combination thereof, such as a visible overlay 510, sub-symbol 511, display area 512, and/or any other visible and/or audible indication.

In the example of FIG. 5B, the multiplier in essence “travels back in time” to be applied to a prior award. It could be applied to an immediately preceding game event, but in the illustrated example it is applied to the last gaining event that resulted in a winning payout award, which in the illustrated example is game event-1 with display grid 504B-1, which is earlier in time and/or sequence to the immediately preceding game event.

The exemplary 3X multiplier of FIG. 5B may be applied to more than one game event. It may be applied to the present game event-N and also to one or more prior (or future) game events such as game event-1. In other embodiments, the multiplier is not applied to the present game event-N, but rather is applied only to one or more past gaming events, such as game event-1. Conditions or rules may be implemented to determine when the multiplier will be applied to a prior game event(s), such as the condition that the current game event-N did not result in a winning payout, or did not result in a payout meeting or exceeding some predefined threshold. This is the case in the illustrated example of FIG. 5B, where no payout resulted from the symbol pattern on the display grid 504B-N, and therefore the awarded enhancement value (a 3× multiplier in this example) is applied to a prior winning payout. In this example the 3× multiplier is applied to the most recent winning payout, which occurred at game event-1 with a win of three hundred (300) credits. Therefore, a current award is based on the presently-obtained 3× multiplier and the previously-obtained payline(s) award of 300 credits, resulting in a total win of nine hundred (900) credits as depicted at display area 514.

In other embodiments, a currently-awarded enhancement value, such as a multiplier, may instead or additionally be applied to one or more future game events. FIG. 5C illustrates an example where an awarded enhancement value, a 3× multiplier in this example, is applied to one or more winning payline awards occurring at a future time/sequence.

As shown in game event-1, a plurality of symbols comprises the display grid 504C-1 For purposes of illustration, assume that obtaining a number of like symbols on a payline results in a positive payout to the player, such as awarding some predetermined number of credits. In the illustrated example, assume that during play of game event-1, the player was awarded with an enhancement value, such as the 3× multiplier 520 depicted as a sub-symbol (although the enhancement value may be presented in any manner).

In the example of FIG. 5C, rules or conditions for applying the multiplier 520 to a future game event are in place, such that if no winning payout is obtained on game event-1 where the multiplier 520 was awarded, it is eligible for application to a future payout. As previously noted, the multiplier 520 could also be applied to the present game event-1, and also to past game events that already occurred. However, in the illustrated example, the multiplier 520 will be eligible for the next future game event in which a winning payout (or winning payout of at least some threshold) occurs, if no winning payout occurred (as depicted by display area 522) in the game event in which the multiplier 520 was awarded.

After obtaining the multiplier 520 award, the player continues to play the game, which results in subsequent gaming events, including game event-2 through game event-N. At various times throughout play, such as at random game events, a winning payline payout(s) may be awarded. In the example of FIG. 5C, the game event-N results in a winning payout on payline (P) 524. The earlier-obtained multiplier 520 travels forward in time to be applied to the game event-N result. The forwarded multiplier 520 may be shown at display area 512 with the game event-N to which it will be applied, and the total winning payout (300 credits times 3 in this example) can be depicted in display area 514 or elsewhere.

Thus, in the example of FIG. 5C, the multiplier in essence “travels forward in time” to be applied to a future award. It could be applied to an immediately succeeding game event (whether a zero or non-zero award), but in the illustrated example it is applied to the next gaming event that results in a winning payout award, which in the illustrated example is game event-N with display grid 504C-3, which is later in time and/or sequence to the immediately succeeding game event.

The exemplary multiplier 520 of FIG. 5C may be applied to more than one game event. It may be applied to the prior game event-1 and also to one or more future (or past) game events such as game event-2, game event-N, etc. In other embodiments, the multiplier is not applied to the game event-1 where the multiplier originated, but rather is applied only to one or more future gaming events, such as game event-N. Conditions or rules may be implemented to determine when the multiplier will be applied to a future game event(s), such as the condition that the game event-1 did not result in a winning payout at the time the multiplier 520 was awarded, or did not result in a payout meeting some predefined threshold. This is the case in the illustrated example of FIG. 5C, where no payout resulted from the symbol pattern on the display grid 504C-1, and therefore the awarded enhancement value (a 3× multiplier in this example) is applied to a future winning payout. In this example the 3× multiplier is applied to the next winning payout, which occurs at game event-N with a win of three hundred (300) credits. Therefore, the payout award is based on the previously-obtained 3× multiplier and the currently-obtained payline(s) award of 300 credits, resulting in a total win of nine hundred (900) credits as depicted at display area 514.

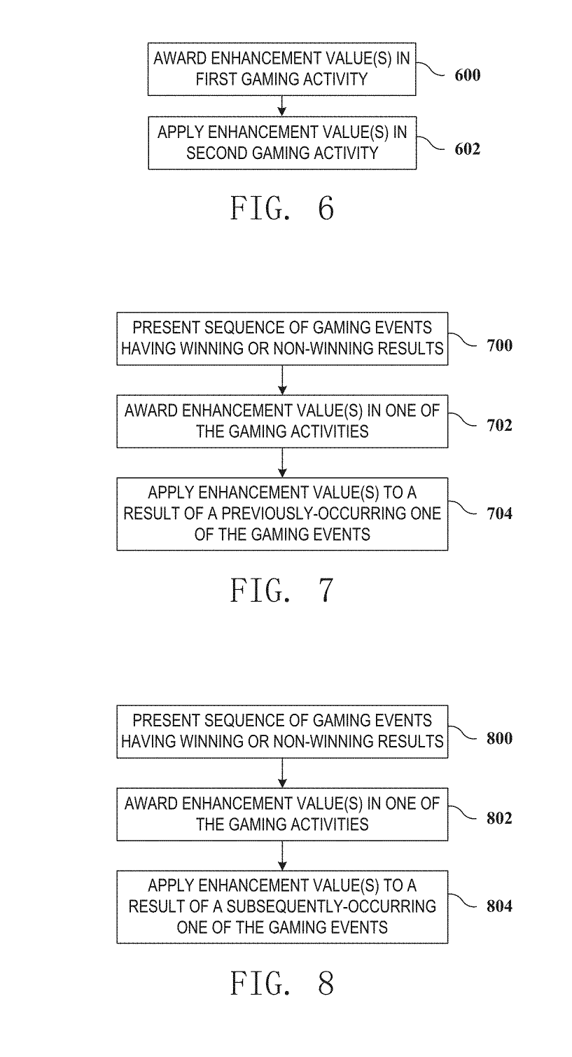

The representative functionality described herein may be implemented in hardware, or a combination of hardware and software, etc. The unique concepts described herein may be described in terms of methods or functionality that is capable of being implemented in programming code operable with computing/processing devices capable of executing the programming code to perform the innovative methods. One representative method is depicted in FIG. 6. In this embodiment, an enhancement value(s) is awarded 600 and a first gaming activity. The enhancement value(s) is then applied 602 in a second gaming activity, such as a second discrete gaming activity that occurred or will occur in a sequence including the first gaming activity.

In another embodiment shown in FIG. 7, a sequence of gaming events having winning or non-winning results is presented 700. An enhancement value(s) is awarded 702 in one of the gaming activities. The enhancement value(s) is applied 704 to a result of a previously-occurring one of the gaming events.

Another embodiment is depicted in FIG. 8, where a sequence of gaming events having winning or non-winning results is presented 800. An enhancement value(s) is awarded 802 in one of the gaming activities. The enhancement value(s) is applied 804 to a result of a subsequently-occurring one of the gaming events.

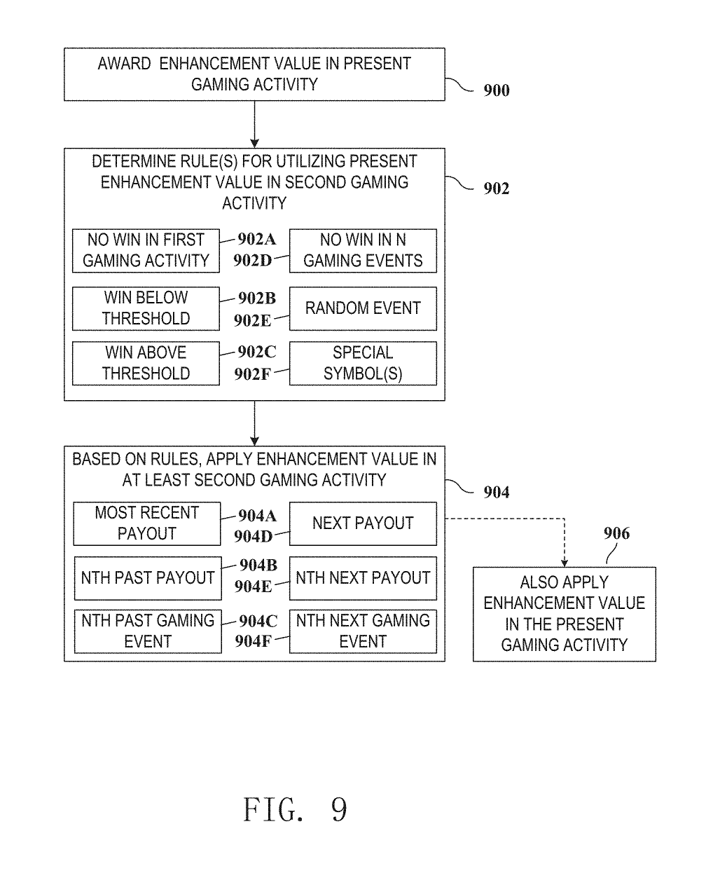

FIG. 9 is yet another flow diagram of a representative embodiment of a method for applying awarded enhancement values across discrete gaming events. In this embodiment, an enhancement value(s), such as a multiplier, is awarded 900 in a present gaming activity. For example, the present gaming activity may be a spin in a slot machine, a hand in a poker game, a card and a bingo game, etc.

In one embodiment, one or more rules are determined 902 for utilizing a presently-obtained enhancement value in a second/different gaming activity. FIG. 9 depicts a non-exhaustive list of illustrative rules that may be used in connection with the principles described herein, while it should be recognized that any desired rules may be utilized. For example, an example rule 902A may be that there is no win (e.g., no non-zero, positive value) awarded in the present gaming activity where the enhancement value originated. Another rule 902B may be that any win obtained in the present gaming activity is below a threshold, such as below some preset number of credits (e.g., 5 credits). Another rule 902C may be that any win obtained in the present gaming activity has to be above a threshold, such as some preset number of credits (e.g., 100 credits). Another possible rule 902D is no win occurring in the sequence of gaming events for a period of N gaming events. Another possible rule 902E includes any random event, such as the multiplier or other enhancement value being randomly enabled for application to a past or future gaming event. The occurrence of a special symbol(s) may be another rule 902F that enables a presently-obtained enhancement value(s) to be applied to one or more other gaining events in the past or future sequence of gaming events. In other embodiments, the multiplier can be applied to the larger of the present win or a past winning payout, or to the smaller of the two, etc. Any desired rule or condition to enable the enhancement value(s) to be applied to a time-shifted or sequence-shifted gaming event may be utilized in accordance with the principles described herein.

In a rule or condition-based embodiment such as that depicted in FIG. 9, the enhancement value(s) may be applied 904 in at least one other gaming activity, depending on the rules/conditions utilized. For example, if rule 902A was applied, then a multiplier or other enhancement value may be applied 904 in a second gaming activity if the first gaming activity resulted in no win. Similarly, if rule 902C was applied, the multiplier or other enhancement value may be applied 904 in the second gaming activity if the first gaming activity was a sufficiently high winner to exceed a threshold to enable the multiplier to be applied 904 to the second gaming activity.

Various embodiments involve different ways of determining which other, discrete gaming activity the enhancement value will be applied. A non-exhaustive list of representative criteria for this decision are shown at block 904 of FIG. 9. For example, the enhancement value may be applied 904 to a second gaming activity, where that second gaming activity is the most recent payout 904A made in the sequence of gaming events. For example, if the last winning payline to result in a winning payout occurred seven spins ago in a slot game, then the enhancement value would be applied 904 to that winning payout that occurred seven spins ago. Other criteria include applying 904 the enhancement value to the nth past payout 904B, to the nth past gaming event 904C, to the next payout 904D, to the nth next payout 904 e.g., to the nth next gaming event 904F, or any other desired criteria.

Other options are also available. For example, in one embodiment, the enhancement value awarded in the present gaming activity is also applied 906 to the present gaming activity where the enhancement value originated. This would be in addition to “time-traveling” the enhancement value to a different gaming event as described herein. For example, conditions may be utilized to know when to apply the enhancement value to both the present gaming activity and the time-traveled gaming activity, such as applying to the time-traveled gaming activity but also to the present gaming activity if the multiplier or other enhancement value originated on or associated with a winning payline in the present gaming activity.

Thus, with many embodiments described herein, there is a chance that a multiplier or other enhancement value is generated during participation in a particular gaming event. If that gaming event results in a win, the multiplier or other enhancement value may be applied to that present win. However, in some embodiments if the present gaming event does not result in a win the player can “time travel” back to a previous winning gaming event and apply the multiplier or other enhancement value to that winning payout. In other embodiments, the enhancement value is kept until the next spin or winning spin. In such situations, the player may hope to get a time travel enhancement value at a different time to use. For example, in a backward time travel, if the player obtains a favorable winning payout, he/she may keep playing in the hopes of obtaining a multiplier later that can time travel back to be applied to the favorable winning payout. In some embodiments, there may be a limit to the number of gaming events backward or forward that the multiplier or other enhancement value may be utilized.

As previously noted, instead of applying a triggered multiplier or other enhancement value to a previous or next win, enhancement value “windows” may be created. For example, a window of five ensuing spins in a slot game may form a “Forward-5” window, and a window of fifty ensuing spins may form a “Forward-50” window. Similarly, Backwards Windows can be created, such as a “back-10” or “back-100” window, where a window of ten and one hundred previous spins respectively in a slot game can be created for use with the traveling enhancement value principles described herein.

FIG. 10 is an example of a Backwards Window enabling a multiplier to travel to apply to one or more previous payout results occurring within a prior time/sequence window. This example assumes a slot game having a plurality of display segments 1002 which may be implemented in discrete video segments, physical or virtual reels, or any other manner of presenting random indicia where pay lines or other pattern results can be determined. The example of FIG. 10 assumes a 3×5 grid of display segments 1002 in which symbols can be presented to determine winning payouts. A sequence of discrete gaming events (e.g., “spins”) occurs during play of the gaming activity (e.g., slot game), which is depicted as sequentially-played gaming events 1000A, 1000B, 1000C, 1000D, 1000E, 1000F, 1000G. It should be recognized that the various gaming events 1000A-1000G may be offset in time as well as sequence, but in other embodiments all gaming events may be presented substantially concurrently, but a sequence of gaming event occurrence is inherently associated with the gaming events or is otherwise assigned to the gaming events.

Any number of different criteria may be utilized to open a Backwards Window. For example, a random event such as a mystery event, occurrence of a special sub-symbol(s) on one or more symbols during a spin, etc. A Backwards Window could also be obtained using player assets, such as trading accumulated or purchased credits, or outright purchasing an opportunity, etc. In one embodiment, a Backwards Window is defined by its duration and multiplier. Backwards Windows are always visible because they already occurred, but may not be active until some event or trigger activates them.

An example set of Backward Windows is shown below

| | |
|---|---|
| Back 5 | 10 |
| Back 10 | 10 |
| Back 25 | 50 |
| Back 50 | 100 |
| Back 100 | 350 |

In one embodiment, each window shows the largest win that occurred in the previous N spins where N is the number of gaming events associated with the window. Upon triggering, the player is presented with a Backwards Window description that pairs a multiplier with the specific window. For example, the specific window identified could be the “Back 25” window, which goes back in time to the last 25 gaming events (sequential, or some defined or random pattern), and identifies the largest win during that window, such as fifty credits in the above example. The associated multiplier or other enhancement value is then applied to the corresponding win and awarded to the player.

For example, using the Backwards Window table above, the player places a bet and receives a Backwards Window 50 multiplier of 3×. The Back 50 value is 100 credits, which is multiplied by three and awarded to the player. The Backward Windows table/information may be presented to and known in advance to the player, or may be hidden and the table or just the awarded window made known to the player upon receiving the Backwards Window award.

The value selected from the window may be the largest payout during the window, the total payout during the window, the average payout during the window, a random winning payout(s) during the window, or any other designed criteria.

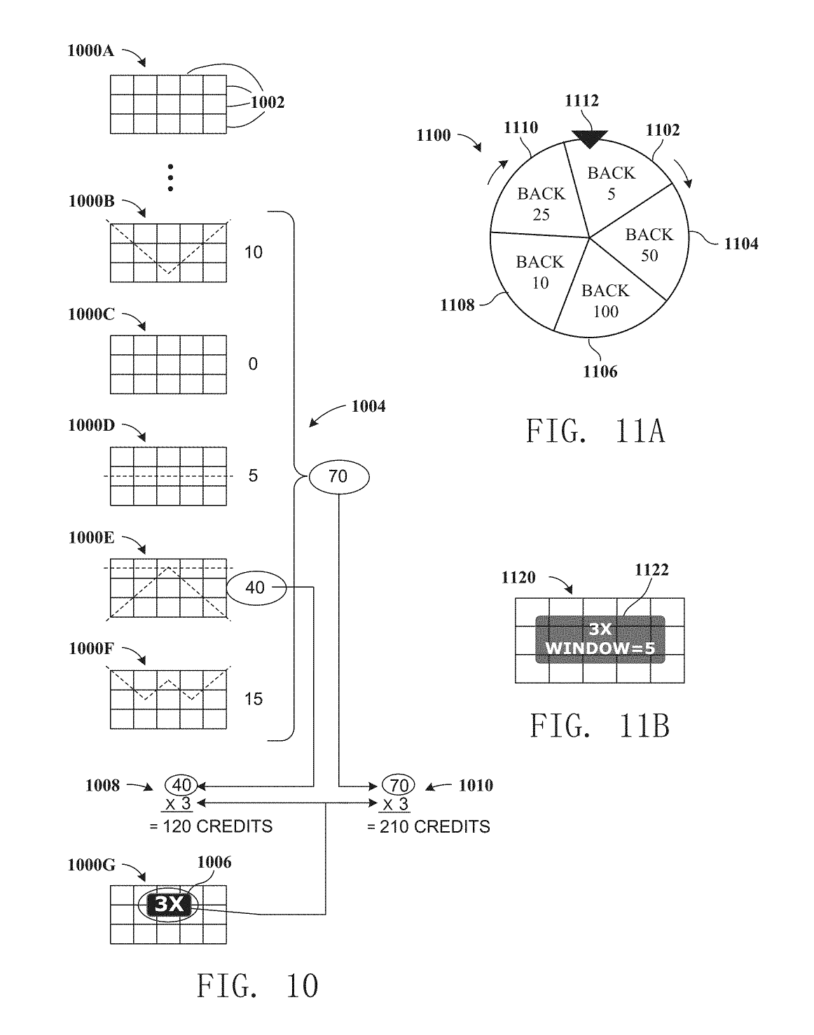

FIG. 10 illustrates an example of a Back 5 window. Assume that a Back 5 window was awarded, thereby having a duration of five prior gaming events, and a multiplier shown in the present example as a 3× multiplier. In some embodiments, the window may be set, such as at the prior five gaming events. In other embodiments, the window may be variable as previously described, where some triggering event specifies the particular range of the Backwards Window that is awarded. As previously noted, this can be randomly designated, such as by way of a sub-symbol or other identifier. In other embodiments, the player may be allowed to participate in the random designation, such as depicted in FIG. 11A. In this example, the player may be notified of obtaining an opportunity to be awarded one of a plurality of Backwards Windows, and be presented with some form of game or feature where such Backwards Window is identified. The example of FIG. 11A depicts a wheel feature 1100, having a plurality of Backwards Window options, including a Back-5 option 1102, a Back-50 option 1104, a Back-100 option 1106, a Back-10 option 1108, and a Back-25 option 1110. The wheel feature 1100 may be activated (e.g., spun) and the indicator 1112 can indicate which of the plurality of options will be used. In the example of FIG. 11A, the “Back 5” window was selected, meaning that the prior five gaming events (e.g., spins) will be considered.

Other manners of designating the Backwards Window can also be used, such as the multiplier and duration simply being indicated to the player as seen in FIG. 11B. In the example of FIG. 11B, a sub-symbol, display in a display area (not shown), and overlay 1122, or other visual and/or audio presentation relating to the gaming event 1120 can be presented. FIG. 11A and FIG. 11B merely provide examples of manners in which the multiplier and or extent/range of the Backwards Window can be designed, as any desired manner of doing so may be implemented.

Returning to the example of FIG. 10, it is assumed that a Backwards Window of five (e.g., Back 5) is somehow specified for this particular time travel event, as depicted by the most recently-occurring five gaming events forming the Back 5 window 1004. In one embodiment, the defined criteria may indicate that one of the gaming events 1000B, 1000C, 1000D, 1000E, 1000F associated with the Back 5 window 1004 will represent the prior payout to which the presently-awarded multiplier 1006 will be applied. For example, the defined criteria may indicate that the largest win associated with the Back 5 window 1004 will represent the prior payout to which the multiplier 1006 will be applied. In such an example, gaming event 1000E represents the largest winning payout during the window of prior five gaming events in the Back 5 window 1004, and therefore forty (40) credits will be used as the Back 5 window 1004 payout to which the multiplier 1006 will be applied. This is depicted at calculation 1008, where 40 credits are multiplied by the 3× multiplier 1006, resulting in a winning payout of 120 credits.

In another example, the defined criteria may indicate that the total wining payouts associated with the Back 5 window 1004 will represent the prior payout to which the multiplier 1006 will be applied. In such an example, gaming events 1000B, 10000, 1000D, 1000E and 1000F are added together to represent the total winning payout during the window of prior five gaming events in the Back 5 window 1004, and therefore seventy (70) credits (10+0+5+40+15) will be used as the Back 5 window 1004 payout to which the multiplier 1006 will be applied. This is depicted at calculation 1010, where seventy (70) credits is multiplied by the 3× multiplier 1006, resulting in a winning payout of 210 credits.

Other manners of identifying a winning payout from the identified Backwards Window (e.g., Back 5 window 1004) may be implemented, such as using an average winning payout from the window 1004, a random selection of one or more winning payouts from the gaming events 1000B-1000F of the identified window 1004, the highest or lowest payout from the window 1004, or any other desired criteria.

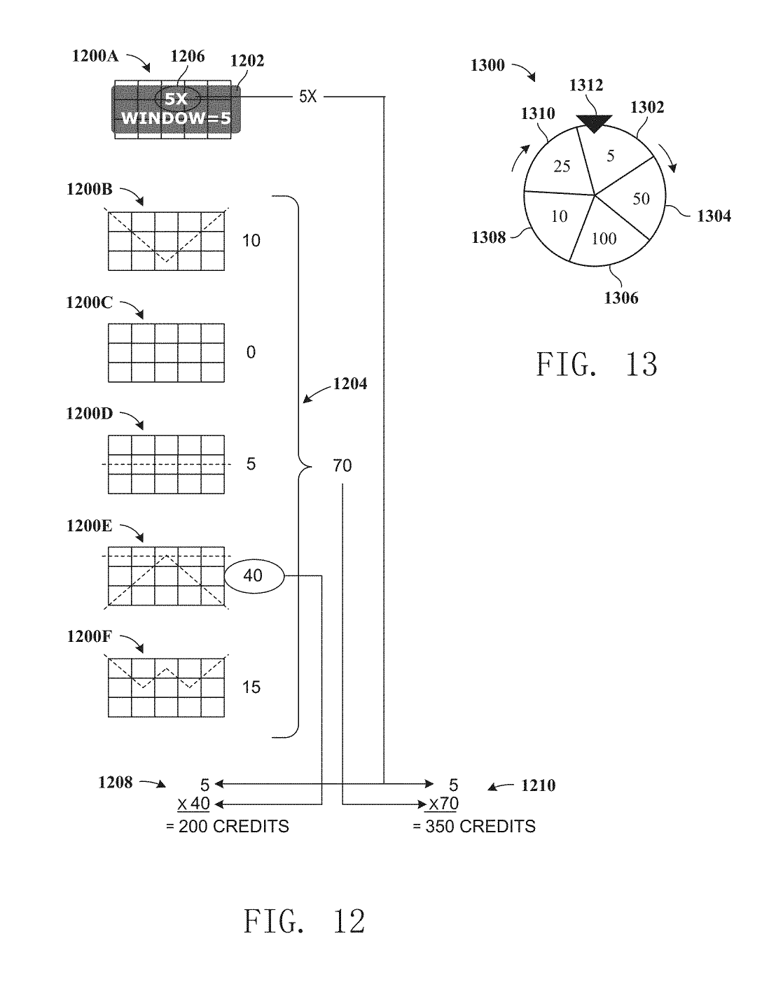

FIG. 12 illustrates an example of a Forward 5 window. Assume that a Forward 5 window was awarded, thereby having a duration of five future gaming events, and a multiplier shown in the present example as a 5× multiplier. In some embodiments, the window may be set, such as at the immediately successive five gaming events. In other embodiments, the window may be variable as previously described, where some triggering event specifies the particular range of the Forward Window that is awarded. As previously noted, this can be randomly designated such as by way of a sub-symbol or other identifier. In other embodiments, the player may be allowed to participate in the random designation, such as depicted in FIG. 13. In example of FIG. 13, the player may be notified of obtaining an opportunity to be awarded one of a plurality of Forward Windows, and be presented with some form of game or feature where such Forward Window is identified. The example of FIG. 13 depicts a wheel feature 1300, having a plurality of Forward Window options, including a Forward-5 option 1302, a Forward-50 option 1304, a Forward-100 option 1306, a Forward-10 option 1308, and a Forward-25 option 1310. The wheel feature 1300 may be activated (e.g., spun) and the indicator 1312 can indicate which of the plurality of options will be used. In the example of FIG. 13, the “Forward-5” window was selected, meaning that the ensuing five gaming events (e.g., spins) will be considered. In other embodiments, the window need not be the immediately succeeding gaming events, but could instead be some any future gaming events corresponding to the window—e.g., a Forward-5 window could begin N gaming events in the future, a Forward-5 window could be constructed of non-successive gaming events in the future, etc.

Other manners of designating the active Forward Window can also be used, such as the multiplier and duration simply being indicated to the player as seen in FIG. 12 at representative overlay 1202 of gaming event 1200A in which the time travel window originated. Sub-symbols, displays in a display areas (not shown), and/or other visual and/or audio random event relating to the originating gaming event 1200A can be utilized.

In one embodiment, a Forward Window will stay active for the number of gaming events (e.g., spins) specified in its duration. For example, a Forward 5 Window would stay active for the next 5 spins, or alternatively for a window of five gaming events later in the play sequence. During that window, the game will track a desired game condition, such as the total win the player achieves during the open window; the highest individual pay during the open window; the average pay during the open window; random selection of one or more individual pays during the open window; or any other desired criteria for selecting the game event outcome during the open window in which to apply the multiplier or other enhancement value.

In the embodiment of FIG. 12, it is assumed that a Forward Window of five (e.g., Forward 5) is somehow specified for this particular time travel window event, as depicted by the next five gaming events forming the Forward 5 window 1204. In one embodiment, the defined criteria may indicate that one of the gaming events 1200B, 1200C, 1200D, 1200E, 1200F associated with the Forward 5 window 1204 will represent the future payout to which the presently-awarded multiplier 1206 will be applied. For example, the defined criteria may indicate that the largest win associated with the Forward 5 window 1204 will represent the next payout to which the multiplier 1206 will be applied. In such an example, gaming event 1200E represents the largest winning payout during the window of next five gaming events in the Forward 5 window 1204, and therefore forty (40) credits will be used as the Forward 5 window 1204 payout to which the multiplier 1206 will be applied. This is depicted at calculation 1008, where 40 credits is multiplied by the 5× multiplier 1206, resulting in a winning payout of 200 credits.

In another example, the defined criteria may indicate that the total wining payouts associated with the Forward 5 window 1204 will represent the next payout to which the multiplier 1206 will be applied. In such an example, gaming events 1200B, 1200C, 1200D, 1200E and 1200F are added together to represent the total winning payout during the window of the next five gaming events in the Forward 5 window 1204, and therefore seventy (70) credits (10+0+5+40+15) will be used as the Forward 5 window 1204 payout to which the multiplier 1206 will be applied. This is depicted at calculation 1210, where seventy (70) credits is multiplied by the 5× multiplier 1206, resulting in a winning payout of 350 credits.

Other manners of identifying a winning payout from the identified Forward Window (e.g., Forward 5 window 1204) may be implemented, such as using an average winning payout from the window 1204, a random selection of one or more winning payouts from the gaming events 1200B-1200F of the identified window 1204, the highest or lowest payout from the window 1204, or any other desired criteria. In other embodiments, there may be an option for the player to cash out and accumulated Forward Window values for credit award.

FIG. 14A depicts a representative method for utilizing time travel windows as described herein. This example includes displaying 1400 sequential gaming events including a present gaming event. These sequential gaming events may be prior gaming events or future gaming events, or both in some cases. An enhancement value, such as a multiplier, is awarded 1402 in connection with the present gaming event. A window of consecutive sequential gaming events relative to the present gaming event is identified 1404. In some embodiments, the window does not have to include consecutive gaming events, but rather can create a window from a plurality of discrete past and/or future gaming events. Therefore, in some embodiments, the gaming events forming a window are not adjacent in sequence, such that any collection of adjacent or non-adjacent gaming events, and/or future or past gaming events, can be designated such that they form a “window.” The enhancement value that was awarded in connection with the present gaming event is applied 1406 to a payout quantity from the window to arrive at a total payout.

FIG. 14B depicts another representative method for utilizing time travel windows. The method includes displaying 1400 sequential gaming events including a present gaming event, and awarding 1402 an enhancement value in connection with participation of the present gaming event. A window of consecutive sequential gaming events relative to the present gaming event is identified 1404. This may involve any desired or contrived “window(s),” including the last N gaming events 1404A and/or including the next N gaming events 1404B. In another embodiment, a plurality of the windows are identified, and at least one of the identified windows is designated, as depicted at block 1404C. Other representative window identifications 1404 may include N gaming events beginning at a later time as depicted at block 1404D, such as beginning five or ten gaming events forward from the present gaming event, or beginning at a random time (e.g., at a random gaming event) forward from the present gaming event, etc. Analogously, window identifications 1404 may include N gaming events beginning at a prior time as depicted at block 1404E, such as ending five or ten gaming events before the present gaming event, or beginning twenty or thirty gaming events before the present gaming event, or beginning at a random time (e.g., at a random gaming event) before the present gaming event, etc.

The illustrated embodiment further depicts representative variations for applying 1406 the awarded enhancement value to a payout quantity from the window to arrive at a total payout. For example, representative payout quantities from the window may be the highest payout value 1406A occurring during the window, the sum 1406B of the payout values occurring during the window, the average of the payout values occurring during the window, etc. Other mathematical functions 1406D may also be used, as can any other desired manner of arriving at a payout value from the window(s) to which the enhancement value(s) may be applied.

In an embodiment that uses multiple game grids in a game (e.g., multiple gaming events are played concurrently), a “space travel” enhancement value may be triggered on at least one of the played gaming events, yet be used on other ones of the concurrent gaming events than that by which the enhancement value originated. The enhancement value, such as a multiplier, may be applied to the gaming event or game grid with the best outcome. In other embodiments, the enhancement value may be applied randomly to one or more of the other concurrent gaming events. In other embodiments, aspects of the “time travel” enhancement value and “space travel” multiplier (or other enhancement value) may be combined so that the best previous award within the multiple gaming events is multiplied by a triggered game multiplier.

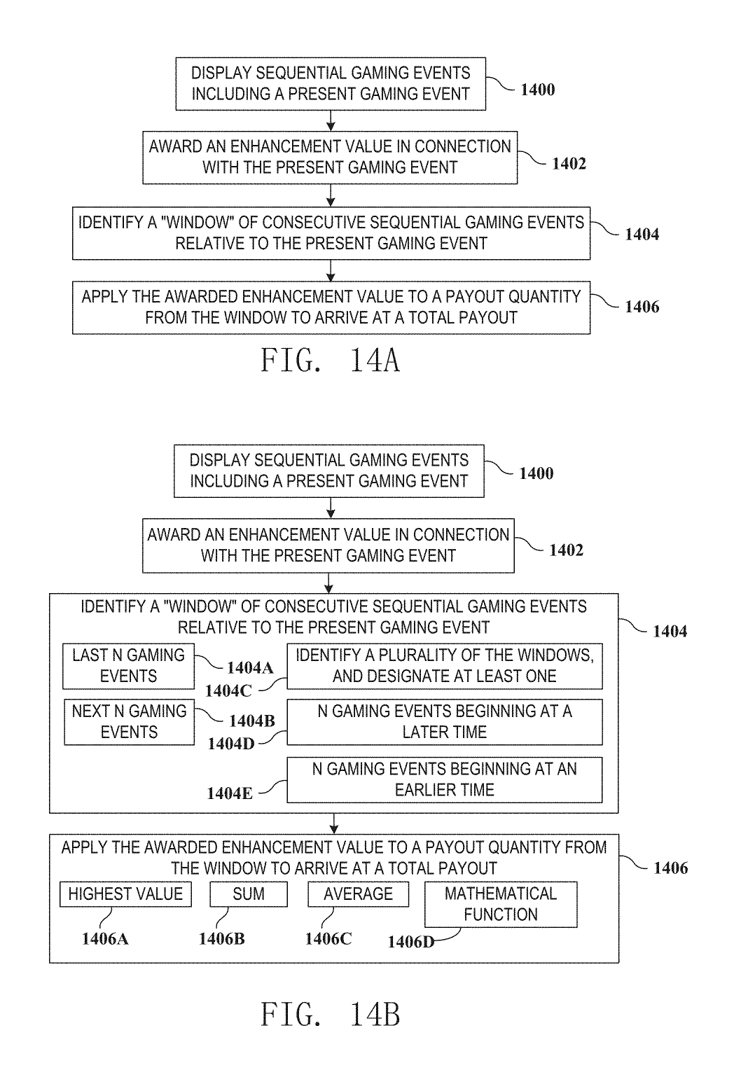

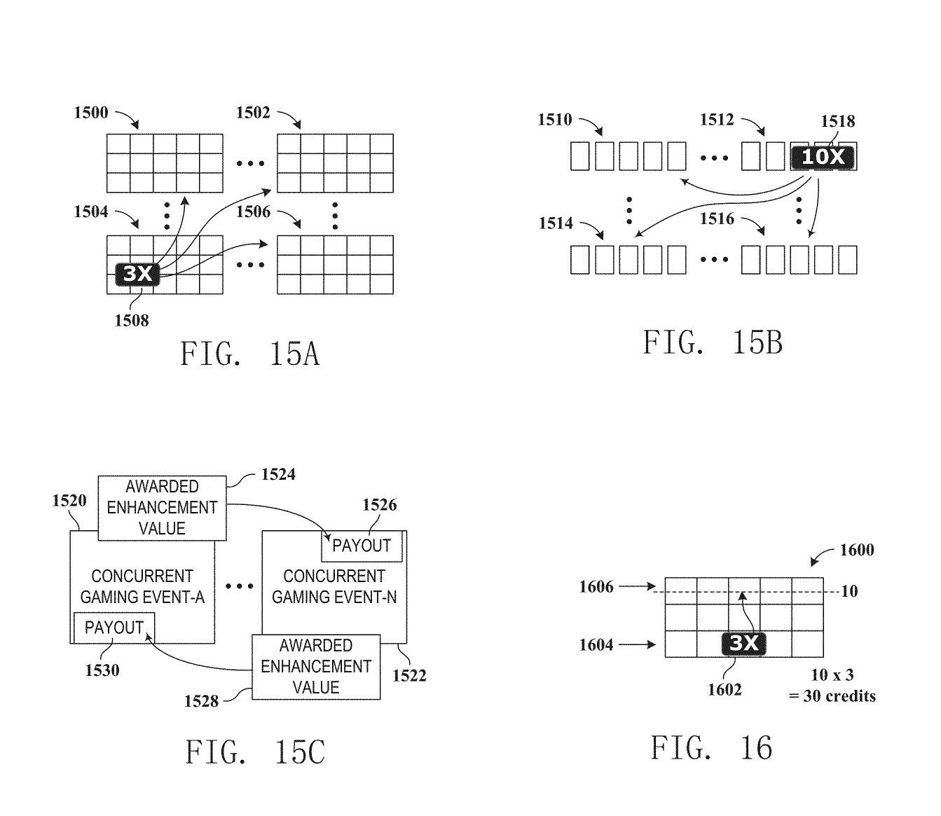

FIGS. 15A, 15B and 15C illustrate space travel payout enhancement embodiments in accordance with the description. FIG. 15A depicts a slot game embodiment, including a plurality of substantially concurrently played slot game events, including at least slot game event 1500, 1502, 1504, 1506 in the illustrated embodiment. An enhancement value 1508, such as the 3× multiplier, occurs in a first one of the plurality of slot gaming events, such as slot gaming event 1504. In accordance with the space travel embodiments herein, the multiplier 1508 may be applied to different ones of the slot gaming events, including any one or more of slot gaming event 1500, 1502, 1506. Conditions or rules may be established to determine which one or more of the other gaming events 1500, 1502 through 1506 will have the enhancement value 1508 applied to its payout(s). For example, in one embodiment, the slot gaming event having the highest payout may be designated as the slot gaming event to which the multiplier 1508 will be applied. In other embodiments, the sum of the payouts of one or more, or all, of the payouts from the concurrently played slot gaming events may be enhanced by the enhancement value 1508. In yet other embodiments, the average of the payouts of one or more, or all, of the payouts from the concurrently played slot gaming events may be enhanced by the enhancement value 1508. As can be seen, the enhancement value 1508 is applied to at least one other gaming event 1500, 1502, 1506 that occurred at a “different space” because there are multiple games being played substantially concurrently. Other embodiments may enable the enhancement value 1508 to also be applied to the slot gaming event 1504 where it originated.

The “space travel” embodiments may be applied to any desired gaming activities, such as slot games, poker games, bingo games, keno games, roulette games, etc. One additional example is depicted in FIG. 15B, which illustrates a poker embodiment. This embodiment includes a plurality of substantially concurrently played card game events, particularly poker game events, including at least poker game events 1510, 1512, 1514, through 1516.

An enhancement value 1518, such as the 10× multiplier, occurs in a first one of the plurality of poker gaming events, such as poker gaming event 1512. In accordance with the space travel embodiments herein, the multiplier 1518 may be applied to different ones of the poker gaming events, including any one or more of poker gaming event 1510, 1514, 1516. Conditions or rules may be established to determine which one or more of the other gaming events 1510, 1514, 1516 will have the enhancement value 1518 applied to its payout(s). As described in connection with the example of FIG. 15A, the targeted payouts may involve the highest payout of the concurrent poker gaming events, the average payout of the concurrent poker gaming events, the total payout of the concurrent poker gaming events, etc. As can be seen, the enhancement value 1518 is applied to at least one other poker gaming event 1510, 1514, 1516 that occurred at a “different space” because there are multiple games being played substantially concurrently. Other embodiments may enable the enhancement value 1508 to also be applied to the poker gaming event 1512 where it originated.

FIG. 15C depicts a more generic example of applying an enhancement value obtained in a first gaming event to a payout obtained in a second gaming event. The example includes any number of concurrent gaming events, identified as concurrent gaining event-A 1520 through concurrent gaming event-N 1522. In a situation where gaming event-A 1520 is awarded an enhancement value 1524, it may be applied to one or more payouts 1526 of other concurrent gaming events, such as concurrent gaining event-N 1522. Analogously, where gaming event-N 1522 is awarded an enhancement value 1528, it may be applied to one or more payouts 1530 of other concurrent gaming events, such as concurrent gaming event-A 1530. This is analogous to awarding enhancement values via a time travel, except that the events may occur substantially concurrently, such that the enhancement values travel in space rather than time.

Other embodiments may involve a “space travel” within a particular gaming event itself. FIG. 16 depicts an example of a slot game, although these principles may apply to other gaming activities as well. The example of FIG. 16 depicts a representative example of an enhancement value space travel, where an enhancement value(s) awarded in portion of a gaming event, such as a payline, and is applied to another portion of the gaming event, such as another payline. In this example, a multiplier 1602 (i.e. enhancement value) occurs on a first payline 1604 that includes the bottom straight row of display segments that make up the display grid 1600. In this embodiment, a multiplier may apply to paylines on which it lands or is otherwise associated with, and if no payout occurs on any of the paylines on which the multiplier 1602 occurs, the multiplier may end up unused. In accordance with one embodiment, the enhancement value(s) (e.g., 3× multiplier 1602) is applied to winning payouts on other pay lines, such as payline 1606 that resulted in a payout of 10 credits. Therefore, in the illustrated embodiment, the player would receive a 3× multiplier for the 10-credit award on payline 1606. In this manner, enhancement values may travel in time and/or space even within the same gaming event. As noted, this intra-event methodology can apply to any type of gaming activity. As an example, a multiplier awarded to one or more locations in a roulette game may be applied to one or more other locations, such as a winning location, when certain criteria to enable the intra-roulette space travel is met.

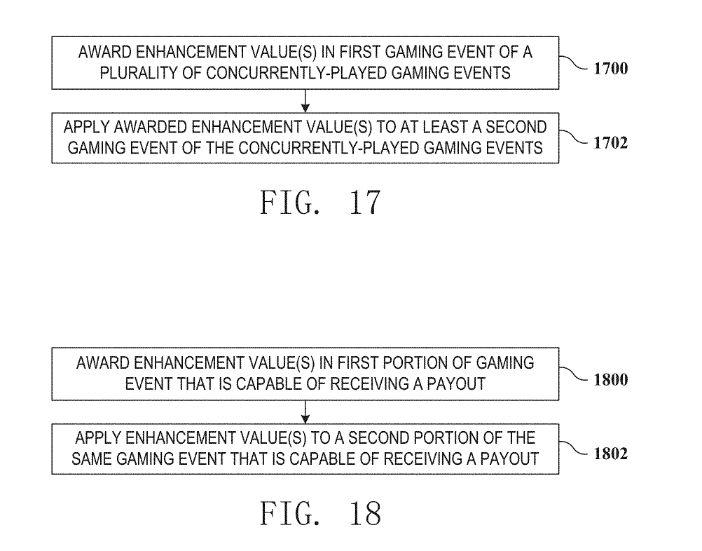

FIGS. 17 and 18 are flow diagrams depicting representative space travel methodologies. In FIG. 17, one or more enhancement values occurring in a first gaming event of a plurality of concurrently-played gaming events is awarded 1700. The awarded enhancement value(s) is applied 1702 to at least a second gaming events of the concurrently-played gaming events. The embodiment of FIG. 18 includes awarding 1800 one or more enhancement values in a first payout-capable portion of a gaming event. The enhancement value(s) is applied 1802 to a second payout-capable portion of the same gaming event.

The foregoing description of the exemplary embodiments has been presented for the purposes of illustration and description. It is not intended to be exhaustive or to limit the invention to the precise form disclosed. Many modifications and variations are possible in light of the above teaching. For example, the present invention is equally applicable in electronic or mechanical gaming machines, and is also applicable to live table versions of gaming activities that are capable of being played in a table version (e.g., machines involving poker or card games that could be played via table games).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out above.

What is claimed is:

1. A gaming apparatus, comprising:
at least one display device to display a plurality of sequential gaming events including at least a present gaming event and a past gaming event;
a wager input device structured to receive physical items associated with player assets that enable participation on the gaming apparatus; and
a processor configured to apply an awarded enhancement value obtained in connection with the present gaming event to a past awarded payout obtained in connection with the past gaming event.

2. The gaming apparatus of claim 1, wherein the processor is further configured to randomly generate the enhancement value obtained in connection with the present gaming event.

3. The gaming apparatus of claim 2, wherein the processor is further configured to randomly generate the past awarded payout obtained in connection with the past gaming event.

4. The gaming apparatus of claim 1, wherein the at least one display device is configured to first display the past gaming event at a first time, and to thereafter display the present gaming event at a second time.

5. The gaming apparatus of claim 1, wherein the at least one display device is configured to concurrently display the prior gaming event and the present gaming event.

6. The gaming apparatus of claim 1, wherein the past gaming event is designated as the most recent past gaming event that resulted in the past awarded payout that is above a threshold, and wherein the processor is configured to apply the awarded enhancement value to the past awarded payout that is above the threshold.

7. The gaming apparatus of claim 1, wherein the processor is configured to determine whether the present gaining event results in a present winning payout, and to condition the application of the awarded enhancement value to the past awarded payout on whether the present gaming event resulted in the present winning payout.

8. A gaming apparatus, comprising:
at least one display device to display a plurality of sequential gaming events including at least a present gaming event;
a wager input device structured to receive physical items associated with player assets that enable participation on the gaming apparatus; and
a processor configured to award an enhancement value obtained in connection with the present gaming event, to identify a window of consecutive ones of the sequential gaming events relative to the present gaming event, and to identify a payout quantity from the window in which to apply the awarded enhancement value to arrive at a total payout.

9. The gaming apparatus of claim 8, wherein the enhancement value comprises a multiplier.

10. The gaming apparatus of claim 8, wherein the processor is configured to identify the window as a number of the consecutive ones of the sequential gaming events that immediately preceded the present gaming event.

11. The gaming apparatus of claim 10, wherein the processor is further configured to generate a plurality of the windows, each having a different number of the consecutive sequential gaming events, and wherein the processor is configured to designate at least one of the plurality of the windows as the window in which to apply the awarded enhancement value to arrive at a total payout.

12. The gaming apparatus of claim 8, wherein the processor is configured to identify the window as a number of the consecutive ones of the sequential gaming events that immediately succeed the present gaming event.

13. The gaming apparatus of claim 12, wherein the processor is further configured to generate a plurality of the windows, each having a different number of the consecutive sequential gaming events, and wherein the processor is configured to designate at least one of the plurality of the windows as the window in which to apply the awarded enhancement value to arrive at a total payout.

14. The gaming apparatus of claim 8, wherein the processor is configured to identify the payout quantity by identifying a highest value payout of the sequential gaming events occurring during the window in which to apply the awarded enhancement value to arrive at the total payout.

15. The gaming apparatus of claim 8, wherein the processor is configured to identify the payout quantity by identifying an average value payout of the sequential gaming events occurring during the window in which to apply the awarded enhancement value to arrive at the total payout.

16. The gaming apparatus of claim 8, wherein the processor is configured to identify the payout quantity by identifying a sum of payouts of the sequential gaming events occurring during the window in which to apply the awarded enhancement value to arrive at the total payout.

17. A method comprising:
presenting a sequence of gaming events, where at least some of the gaming events provide results indicative of a winning result or a non-winning result to the player;
presenting at least one enhancement value in connection with a presently-occurring one of the gaming events;
applying the at least one enhancement value to the winning result of a previously-occurring one of the gaming events.

18. The method of claim 17, further comprising identifying a most recent one of the winning results, and wherein applying the at least one enhancement value comprises applying the at least one enhancement value to the identified most recent one of the winning results.

19. The method of claim 17, further comprising identifying at least one window of consecutive ones of the sequence of gaming events occurring before the presently-occurring one of the gaming events, and identifying the winning result of the previously-occurring one of the gaming events as a highest winning payout result among the gaming events identified in the window.

20. The method of claim 17, further comprising identifying at least one window of consecutive ones of the sequence of gaming events occurring before the presently-occurring one of the gaming events, and identifying the winning result of the previously-occurring one of the gaming events as the winning result of any one or more of the gaming events identified in the window.
